(19) United States
(12) Patent Application Publication
(10) Pub. No.: US 2001/0051928 A1
(43) Pub. Date: Dec. 13, 2001

(54) Protection of software by personalization, and an arrangement, method, and system therefor

(76) Inventor: Moshe Brody, Kfar Saba (IL)

Correspondence Address: Moshe Brody, Rehov Nahum 6, Kfar Saba, 44338, IL

(21) Appl. No.: 09/827,670

(22) Filed: Apr. 5, 2001

Related U.S. Application Data
(60) Provisional application No. 60/199,373, filed on Apr. 21, 2000.

(51) Int. Cl. H04L 9/00; G06F 12/14

(52) U.S. Cl. 705/52; 713/193

(57) ABSTRACT

An arrangement, method, and system for personalizing published software according to the specific authorized user, and thereby offering protection against unauthorized copying and distribution by discouraging the authorized user from indiscriminately making and distributing unauthorized copies. The personalization is incorporated into the software build and is delivered to the authorized user with embedded pre-existing personal information, without requiring the user to input this information during setup or installation. Because the personal information has already been pre-incorporated into the deliverable published software upon receipt by the authorized user and does not require any manual entry by the user, it is feasible to employ strong cryptography using complex keys for authentication and other protective purposes. Moreover, because each delivery to an authorized user results from an individually-personalized software build, the executable modules of each distributed authorized copy of the software will have a unique binary form that can be made to vary significantly, including variations in the size of the executable module, while still having completely identical user functionality. This variation provides further protection to the software by eliminating the constant program address locations that are easy to analyze and attack with automated protection-disabling programs. Also disclosed are novel methods of utilizing an embedded strong personalization in Java applications and applets in combination with the use of signed Java archive files to afford additional protection to the software. Software protected according to the present invention may be distributed on physical media as well as via networks, but the invention is particularly well-suited to protecting software distributed via networks, such as the Internet, where prior-art protective measures are weak, clumsy, vulnerable to attack, or inapplicable.

### FIELD OF THE INVENTION

The present invention relates to the protection of computer software and, more particularly, to the protection of a software application by incorporating a personalization therein.

### BACKGROUND OF THE INVENTION

Considerable attention has been directed toward the problem of unauthorized copying and distribution of software. Unauthorized copying and distribution is done not only by clandestine organizations who illegally reproduce and commercially market and sell software in violation of copyright law (the so-called “pirate” operations), but also by individual users, generally on a gratis basis to relatives, social acquaintances, business associates, employees, and co-workers. The practice of unauthorized copying and distribution by individuals is generally referred to as “casual copying”, and although not done for profit, this practice of casual copying is believed to adversely impact the sales of legitimate software by software publishers.

To better understand the limitations of prior-art software protection systems, it is helpful to review the prior-art software publishing and distribution process which is universally employed today. This is illustrated conceptually in FIG. 1. In a step 102, a software publisher develops software 108. There are two ways of distributing software 108 to customers. The older of the two ways is via physical distribution. In a step 104 the software publisher manufactures the software on media and optionally provides a software key or hardware key 110-A (discussed below) and optionally provides a serial number 110-B (discussed below) to accompany the software. Then, in a step 106 the software publisher or a retailer distributes software 108 on media to customers, optionally providing software key or hardware key 110-A and optionally providing serial number 110-B. The newer of the two ways is via network distribution. In a step 112, the software publisher or retailer makes software 108 available to customers on a network. In a step 114, the software publisher or retailer optionally provides a software key via the network and optionally provides serial number 110-B via the network. Because the network is able to directly deliver information only, but not physical material, the optional key is limited to being a software key. The case where physical media-based software is ordered by a customer via a network is a variant of the traditional physical distribution channel, rather than a true network distribution, because the use of a network for placing an order is actually incidental to the process of physical distribution. In any case, the customer obtains the software and optional software key or hardware key 110-A and optional serial number 110-B in a step 116, thereby completing the distribution process. If optional serial number 110-B is provided, then in step 116, the customer may subsequently be associated with serial number 110-B (as a customer number, license number, etc.).

It should be noted that, even though true network distribution of software is currently being done and is increasing dramatically, prior-art network distribution is essentially merely a network-enabled version of the traditional physical media distribution channel. Indeed, software publishers tend to view network distribution in most cases as a parallel channel for physical distribution. This perception of network distribution as simply an electronic version of physical distribution with certain economic and marketing advantages is a limiting perception, because network distribution, in addition to being a superior way of distributing software even when considered as merely a virtual counterpart, possesses a number of distinct capabilities which are completely absent from the traditional physical distribution channel, and these capabilities enable new possibilities for software protection, as are described herein.

Prior-art methods and systems for protecting software against unauthorized copying and distribution may be classified into one or more of the following categories:

### Copy-Protection Schemes

Authorized copies of copy-protected software are furnished on special media which may have non-standard physical characteristics or data formatting which deviates from the normal standards. The intent is that either the software recorded on the special media cannot be copied onto regular media via normal copying procedures, or that the software or the program that installs the software can determine, when executing, whether the media conforms to the characteristics of the special media of an authorized copy or to the normal characteristics of regular media. In the case of regular media, the software or the program that installs the software may cause certain action to be taken, including, but not limited to disabling of the software or aborting the installation, thereby rendering the unauthorized copy unusable.

Such copy-protection schemes, however, have not been very successful. Popular software which has been copy-protected is subject to attack, the aim of which is to remove or evade the copy-protection measures. Most copy-protection schemes rely on technical obscurity for security, and therefore do not inherently possess a high degree of resistance to attack. Although they may seem initially formidable, technically-sophisticated attackers have the skill and resources to analyze and understand such copy-protection mechanisms in spite of their obscurity, and the copy-protection schemes for popular software have all been broken relatively quickly. The breaking of a copy-protection scheme has often been quickly followed by the publication and widespread distribution of computer programs which automatically remove the copy-protection measures from the software. Even without a financial incentive to break these copy-protection measures, many skilled attackers seem to enjoy defeating copy-protection simply as a challenge. Moreover, copy-protection measures often adversely impact the legitimate usability of the software they are meant to protect, and this has resulted in massive consumer resistance to copy-protection. Software publishers have therefore generally abandoned copy-protection rather than risk market rejection of their software products.

### Usage Control Schemes

Usage control is independent of copy-protection, because under such a scheme, the software is not usable without a separate usage control element (described below). Many software publishers who rely on usage control, in fact, encourage their users to make spare, or “backup copies” of the software. There are a variety of prior-art techniques for accomplishing usage control.

One simple prior-art technique for usage control involves the requirement that the user enter a password during setup of the software. Such passwords typically consist of a sequence of data, such as a character string, and are sometimes referred to as “software keys”. In many cases, a common serial number is used for an entire edition or version of software, and is employed as a software key or password. The password may be supplied in written form on paper or on a label and entered manually by the user, or may be entered electronically by another computer or computer program. The theory behind such schemes is that an unauthorized copy is liable to become separated from a written password or from another program that enters the password, and will therefore become unusable. In the majority of cases, however, it is the user who must enter the software key manually, and it is a relatively simple matter to label the password directly onto the unauthorized copy. In addition, extensive lists of such software keys for many popular software titles are widely available on the Internet. Thus, the protection offered by such a scheme is easily defeated.

Another prior-art technique for usage control exploits the fact that each individual computer is likely to exhibit a unique set of certain parameters (such as processor serial number, characteristics of the hard disk partitioning, directory structure, the operating system registry, user associated with the computer, etc.). This set of parameters is herein referred to as the computer's configuration. During setup, the setup program determines the configuration, optionally writes special keys into the operating system registry, and instructs the software to check for the particular values of this configuration. If the outcome of the check is not positive, the software considers that a different computer system is being used, and may trigger a program termination. Other options of such techniques include limiting the amount of time (such as the number of calendar days) or the number of times the software is operated before a software key must be entered by the user. This technique, however, also often fails to achieve the desired results. Where the computer's internal state information is relied upon to determine the configuration, there are sometimes problems involved in reliably recognizing a specific computer's internal state information. Such schemes also rely heavily on modifying the operating system registry to contain hidden information related to the configuration, or on creating and manipulating hidden files with the configuration. Once again, the security of this depends on technical obscurity, and offers no fundamentally sound protection against sophisticated users who know how to monitor, detect, undo, and otherwise control these modifications.

Still another prior-art technique for usage control involves employing a central database of authorized users. Operation of the software may require some form of authorization by the central database. Such a scheme can be made quite secure, but suffers from the disadvantage that connection to a central database is usually neither practical nor acceptable to most users, even in environments that support widespread global connectivity, such as the Internet.

Yet another prior-art technique for usage control involves the employment of a hardware accessory such as a smart-card or a hardware key (popularly known as a “dongle”) that plugs into an input/output port of the computer. In the former case, the software is programmed to operate only if the user presents the correct smart-card (to a smart-card reader connected to the computer) when the software is loaded. In the latter case, the software is programmed to check for the presence of the hardware key during operation, and to operate only if the hardware key is present. The effectiveness of this technique benefits from the difficulty of physically copying the smart-card or the hardware key that is associated with the software, and the fact that such devices can employ cryptographic methods offering reasonable security levels. This technique is therefore relatively effective in controlling usage (and thus in protecting the software from unauthorized use), but suffers from the disadvantage that the associated smart-card or hardware key is cumbersome, expensive, and relatively difficult to distribute. In addition, although the hardware key itself may be relatively immune to tampering, the software is not, and may be attacked by skilled persons to remove or alter code that accesses the hardware key, thereby rendering the protection ineffective. This technique is therefore limited to being used with expensive specialty software in safe environments and is not practical with inexpensive software applications or software applications that are widely distributed and used in environments where attackers can gain access to the software code. This technique of usage control is also not practical in most cases with software distributed over networks, such as the Internet, because of the requirement that the user have a physical hardware key. Unless the user already has the appropriate hardware key, it is not feasible to distribute software protected by such usage control over a network.

A more recent variation on usage control schemes is disclosed in U.S. Pat. No. 5,708,709 to Rose (hereinafter denoted as “Rose”), which involves placing an “application builder” in the user's computer, to verify each use of the software. The software is encrypted so that it cannot be directly executed, and is enabled only by the application builder, after the application builder verifies the user (or the user's computer). Thus, the software can be remotely accessed by the user over a network, or accessed locally. The principle of Rose is that, because the software is encrypted and is not directly executable, the user cannot distribute working copies of the software, thereby preventing unauthorized copying and distribution. Only the application builder can decrypt and load the software for execution. The protection afforded by this concept, however, is only as secure as the application builder. If the application builder is successfully attacked, then clearly the software can be decrypted and run without any protection at all, also permitting unauthorized copying and distribution of the software along with the compromised application builder. In particular, it is noted that in Rose the application builder relies on having both a public and a private key available within the user's computer. Thus, because the private key is theoretically available to an attacker (by analyzing the application builder), the method disclosed by Rose provides no level of cryptographic security. In fact, if the same application builder is used for a number of software applications, then breaking the application builder would simultaneously break the security of all those software applications.

### Identification And Tracking Schemes

In certain cases, software publishers have chosen not to implement any form of copy-protection or usage control, but rather to provide means of auditing the copies of their software through “identification and tracking” schemes.

The simplest identification and tracking technique consists of recording a unique serial number on each authorized copy of the software (at the time of manufacture of the authorized copy). In this scheme, when a user purchases a license to use the software, he or she is given a serialized authorized copy, and the serial number is recorded and associated with his license purchase, for example in a database maintained by the software publisher. Such a user thus becomes a registered authorized user of the software. Subsequently, however, if an unauthorized copy is made from the authorized copy of that registered authorized user, the unauthorized copy will have the serial number of the registered authorized user, and the unauthorized copying and distribution can thus be traced back to the registered authorized user from whose authorized copy the unauthorized copy was made. Depending on the license agreement, the registered authorized user may be held accountable for the unauthorized copying and distribution. In this a manner, it is believed that such identification and tracking can deter unauthorized copying and distribution by establishing accountability of registered authorized users. It is believed that this accountability will discourage registered authorized users from actively engaging in such practices, and will encourage them to take steps to forestall unauthorized copying and distribution by others who have access to authorized copies of software in their care.

One problem with this simple identification and tracking scheme as described above is that it is relatively easy for a technically-sophisticated attacker to determine the location in the software code where the serial number is stored, and to replace the valid serial number with a bogus serial number. Once this is done, unauthorized copies will not be identifiable or trackable. A way of overcoming this limitation is disclosed in U.S. Pat. No. 5,287,408 to Samson (herein referred to as ‘Samson’). According to Samson, allowable serial numbers are generated by a mathematical generating function and can be validated by a different mathematical verification function, and Samson gives an example of such a mathematical “one-way” generating function and validation function. According to Samson, the validation function is embedded in the software, and will cause a program termination if the embedded serial number fails the validation test. Although the validation function is potentially available to an attacker, the generating function (or a cryptographic key thereto) is not available, and for suitable generating functions the probability that the attacker will be able to guess a serial number that will pass the validation test can be made insignificantly small.

Samson, however, also suffers from limitations. Primarily, the concept of identification and tracking based on serial numbers in a database of registered authorized users is practical only for relatively expensive specialty software that is sold to a relatively small base of high-profile registered authorized users. The serial numbers by themselves have no significance or meaning to users and must be translated into names through the use of the central database. The costs of identification and tracking unauthorized copies via a database of such serial numbers is prohibitively high for the inexpensive software applications that constitute the overwhelming bulk of the general software market.

Furthermore, although it may be effectively impossible for an attacker to generate serial numbers that will pass the validation test, it is still feasible for a sophisticated attacker to modify the software to bypass the disabling code and thereby evade the program termination that would normally result from an invalid serial number. In practice, this can be done by modifying the validation function of the software to operate as if all serial numbers are valid (including otherwise bogus serial numbers). Once the validation function code is located within the software, it is practically as easy to make such a modification as it is to alter the embedded serial number. Thus, despite the technique disclosed by Samson, it is still possible to modify the protected software to substitute an untrackable bogus serial number, or delete the serial number altogether, and thereby produce fully-functional unauthorized copies of the software for which no registered authorized user can be held accountable. The principal value of Samson is therefore in enforcing license compliance among visible registered authorized users, rather than in preventing or deterring unauthorized copying and distribution in general.

Two other limitations of Samson should be noted: First, Samson teaches only a program termination as a response to the case of a serial number failing the validation test (such as, “. . . an error message is generated and the program exits”). This is the general approach to handling an unauthorized copy in the physical media distribution culture to which Samson is addressed. In network distribution of software, however, other actions are desirable as options, and limiting response to a program termination is overly restrictive and non-responsive to the overall needs of network-based software publishing. Second, although Samson also discloses a method for optionally personalizing the software, the personalization according to Samson is applied by the user during setup (“installation”). As noted below, having the user apply the personalization during setup is of limited value in offering protection to the software. In the Samson scheme, however, such personalization is incidental, and the protection offered by Samson relies entirely on the special serial numbers. Indeed, the only form of unique identification available in the physical media distribution culture is some sort of serial number scheme. In prior-art personalization techniques, truly personalized data pertaining to the eventual user is not known at the time of software manufacture and can be applied only by the user during the setup process.

### Network Software Execution

It is relatively easy to control user access to software that exists on a network, such as the Internet, provided that the software is executed remotely by the users over the network, rather than being downloaded to the users for local execution on their own computers. Controlling remote user access to such software over a network essentially involves authenticating the remote user, and a method for doing so is disclosed in U.S. Pat. No. 5,872,915 to Dykes, et al. (hereinafter referred to as “Dykes”), in which the user's web browser is authenticated. Such techniques, however, are appropriately considered as security measures, rather than for limiting unauthorized copying and distribution. Authenticating a web browser, as is done in Dykes, for example, will not prevent unauthorized users from accessing the protected software remotely if they are given an exact copy of the authenticated web browser. Moreover, techniques such as those presented in Dykes are ineffective in protecting software which is downloaded over the network and executed locally.

### Current Java-Based Network Software Distribution

Currently, the only software which is distributed principally, if not exclusively, by network is predominantly software intended for network applications, virtually all of which is written in the Java language. Java is a platform-independent language intended for use across a spectrum of operating systems and hardware configurations that would likely be found on a computer network, such as the Internet. A software publisher can develop a software application or applet for distribution over the Internet, and be confident that the developed software will function substantially the same on any computer that supports Java executables, regardless of the hardware or operating system environment.

The ease of Internet distribution means that Java-based software can be downloaded to a user in real-time, while that user is connected to the Internet, and small Java executables (generally known as “applets”) can be automatically downloaded to, or executed by, the user's computer to perform tasks while the user is browsing a particular website. The ease by which this process may be carried out, and the fact that the user is generally unaware that such software has been downloaded into his or her computer, has created a major security risk for the user. Without adequate security arrangements in place, it would be possible for unscrupulous persons to download malicious Java-based software into the computers of unsuspecting users and thereby cause possible harm to these users. As a result, considerable attention has been paid to establishing a secure computer environment for the execution of Java-based software. Initially, this was done by providing only limited resources (commonly known as a “sandbox”) to the downloaded Java applet. These limited resources, for example, preclude access to the computer's file system. Subsequently, an authentication procedure was developed, by which a digital signature can be applied to Java software, to produce a “signed software application” (discussed in a following section entitled “Extending the Java Protection Mechanism to Protect Software from Unauthorized Copying And Distribution”, wherein the digital signature is denoted as an “archive signature” because of being used in the authentication of a Java archive). The digital signature is applied according to well-known public key cryptosystem technology, and, if recognized by the user's secure computer environment as having come from a trusted source, the corresponding Java software application is given access to more extensive resources of the user's computer. A trusted Java software application carrying such a digital signature, for example, can be executed in a normal fashion to have access to the full set of resources of the computer, and can read and write files the same as a regular software application. Such prior-art methods for protecting client computers are disclosed in U.S. Pat. No. 5,974,549 to Golan, and U.S. Pat. No. 5,978,484 to Apperson, et al.

Unfortunately, however, this concern to protect the user from attack has been the overriding security issue for use with Java software, with the result that there are no means currently available for protecting Java software from unauthorized copying and distribution by the users. Indeed, as noted previously, the key benefit of using Java is that software developed in Java is independence of specific computer architectures and operating systems. A software application or applet developed in Java will run substantially the same on any platform. Although this is extremely advantageous, a consequence is that Java software is isolated from the computer's hardware and operating system in such a way that it is extremely difficult to provide any degree of software protection based on a relationship between the software and tangible entities related to the authorized user, such as the computer, the operating system, or the media. A prior-art suggestion by Java users, and published via the Java forum provided over the Internet by Sun Microsystems, Palo Alto, Calif. (the developer of Java at http://forum2.java.sun.com/forum?14@@.ee788c2, Jan. 8, 1999), is that it might be possible to augment the Java Virtual Machine (the local interpreter program that executes the Java code) with a function or procedure that returns an identifier that is unique (or substantially unique) to the hardware/operating system installation upon which a Java applet or application is being run. As proposed in this prior-art suggestion, some non-Java platforms provide a means to read a serial number from the computer's processor. On other platforms, it may be possible to derive an identifier using configuration information, in a manner similar to the prior-art technique for usage control previously discussed, which exploits the fact that each individual computer is likely to exhibit a unique set of certain parameters (such as characteristics of the hard disk partitioning, directory structure, the operating system registry, etc.). In theory, it might then be possible to record such an identifier when the Java software is installed, and then check the identifier each time the software is run to make sure that the software is being run on the same system where the installation was originally done. While this suggestion might theoretically work, there are problems in implementation that could interfere with successful operation. First, the platform-independence of Java means that it may not be possible to obtain the required identifier on every system. And second, even on systems where an identifier could be obtained, the Java Virtual Machine would have to be individually altered for each platform to accommodate the new function or procedure. Finally, even if these problems were overcome, such a scheme confronts the user with precisely the same unreasonable limitations that has led to the failure and market rejection of other prior-art usage control schemes. In addition, there is no guarantee that skilled attackers would not be able to find general methods to defeat such a scheme. Thus, this prior-art suggestion does not satisfactorily address the need for protection of Java-based software.

The lack of software protection for Java-based software is currently not a serious deficiency, since the bulk of Java software is in the form of small auxiliary utilities which are commercially useful in the context of Internet use, but have little or no commercial value as independent software, and hence are distributed free of charge. Thus, most software publishers currently developing software applications and applets in Java do not care if users engage in unauthorized copying and distribution. This situation is changing, however, as Java-based software gains wider acceptance for a broader class of tasks. There is thus a growing need to protect Java-based software from unauthorized copying and distribution, and, as discussed above, prior-art techniques do not provide protection in the Java environment.

### The Current Software Distribution Culture and Limitations Resulting Therefrom

All of the prior-art techniques discussed herein were developed during an era when the only practical means for distributing software involved the physical distribution of the software, as recorded on physical media. This necessitated manufacture of the software in advance of distribution to authorized users. The constraints of this distribution culture have put severe limits on the ability to protect software. As noted above, for example, individualization of the authorized copies of software at the time of manufacture is currently limited to the embedding of serial numbers which can only later be associated with authorized users at the time of licensing. As discussed herein, this limitation prevents the implementation of superior protective measures.

The current software distribution culture based on physical manufacture, however, is beginning to change radically because of the growth of networks, principally the Internet. Distribution of software via the Internet is increasing at a rapid rate, because the Internet is ideal for software publishing and distribution. Users can browse through an enormous selection of available software titles from all over the world, examine reviews and comparisons, and obtain software, often on a “try-before-buy” basis, almost immediately at more favorable pricing and with negligible delivery delays and overhead. Internet distribution is also highly favorable to software publishers, especially new and smaller ones who are unable to access traditional store-front or catalog distribution channels. Because software is inherently manifest as information, Internet distribution can also eliminate the need to manufacture software, thereby greatly reducing the cost and waste of media, printed manuals, packaging, and the like, and allowing updated versions to be released instantly with minimal overhead.

Although distribution of software via the Internet is experiencing phenomenal growth, however, most traditional software publishers still perceive a need to distribute software in physical form through parallel channels, particularly where the software involves large amounts of code that is time-consuming to download via slow dialup connections, but which can be economically distributed via high-density media such as CD-ROM and DVD. While such a market for software in physical form is still important and will remain important for some time to come, the relative size of this market is rapidly diminishing, and with improved Internet bandwidth and server capabilities, it is expected that before long the Internet will become the dominant channel for software publishing and distribution.

There is thus a need to re-examine prior-art concepts of software protection. In particular, prior-art techniques of software personalization and the utilization thereof for protecting software (discussed below) are severely limited by the culture of the obsolescent physical distribution channel, and can benefit greatly by exploiting the freedom from physical media offered by Internet and other network-based software distribution channels. Software publishers have generally lost faith in the prior-art techniques of copy-protection, usage control, and identification and tracking. The failure of these prior-art techniques to live up to initial expectations, and their general rejection by the marketplace have led to repeated disappointment and loss of customer confidence. As noted below, however, some degree of software protection is warranted, and prior-art techniques cannot currently provide this.

### Computer Domains

As is well-appreciated, computers exhibit a broad variety of different hardware designs and arrangements. The realms of different “types” or “classes” of computer are herein referred to as “domains”. Domains include, but are not limited to, the realms of “mainframe” computers, “supercomputers”, network servers, personal computers, personal digital appliances, and so on. Computing power and processing capabilities are not the primary distinction between these different classes of computer, because technological advances have consistently increased the capabilities of computers. An up-to-date personal digital appliance is much smaller than an early-model personal computer, for example, but can have considerably more processing capacity and memory. The principal distinctions between the domains lie in the modes and patterns of intended use for the computer, as is detailed herein.

The distinction of domain is of great importance in considering the issue of software protection, and while the principles of the present invention are applicable without limitation to all domains, types, and classes of computer, special attention is given to the domain of the personal computer, as discussed below.

Generally, a “personal computer” (“PC”) tends to be characterized by having a file-based operating system which supports one user at a time, and includes provision for large-scale file storage (e.g., a “hard disk”), removable media (floppy disk and/or optical disk), optional network connectivity (e.g., via modem, including dial-up connections), and optional peripheral devices (such as printers, scanners, smart card readers, multi-media accessories, and the like). The huge popularity of personal computers, coupled with a large variety of potential hardware formations has caused the PC to become a commodity of merchandise, with the result that the market is served by a large number of different manufacturers and vendors. While the software and operating systems have become rigidly standardized, the hardware is not subject to the same degree of standardization. Although PC's are relatively small in comparison with traditional computing systems, they are nevertheless still not highly mobile. Even portable versions (commonly referred to as “laptop” or “notebook” computers) tend to be used in a stationary position with respect to the user (such as on a desk or table, when the user is sitting, even in a moving environment such in an airplane). The result is that users often find themselves using different PC's to handle their work at different places in their travels during the day. For example, it is common to find users having PC's at home, portable “notebook” computers to take to work, and PC's connected to company networks in their offices, all of which they may use during the regular course of the day. A consequence of this is that these users may need to share software and data files among a number of different PC's. Furthermore, in many work-related situations, the data files handled by PC's can become relatively large and complex and may require the cooperative work of a number of different individuals. In addition, therefore, users may need to share data files with a number of other people, who similarly utilize a number of different PC's. This in turn requires software to be readily transportable from one PC to another for legitimate use (the same user needs to run the software on several different PC's), but introduces a challenge in protecting the software from unauthorized copying and distribution, since there is no fundamental technical difference between copying the software onto the user's “notebook” computer (a legitimate use) and copying the software onto a network (unauthorized copying and distribution). As noted previously, technical factors related to the lack of hardware standardization and the open nature of the standardized operating system environment limit the options available for effective software usage control. The protecting of the software by personalization according to the present invention is especially well-suited to addressing the need for software protection, because the personalization avoids these limitations and places no undue restrictions on authorized users, but still achieves the goal of discouraging unauthorized copying and distribution.

In contrast to a personal computer, a “personal digital appliance” (“PDA”, sometimes referred to as a “personal digital assistant”) normally has little in the way of peripheral gear or accessory devices, being a very compact device that conveniently fits into a pocket, operates entirely on self-contained batteries, and is normally used while being held in the hand (and is thus sometimes referred to as a “hand-held” computer). Exemplary PDA's include the “Palm” device, manufactured in several versions by 3Com, and comparable, highly similar devices made by several other manufacturers. Although PDA's are immensely popular, there are relatively few manufacturers of PDA's in comparison to the large number of manufacturers of PC's, because PDA's are completely integrated devices, whereas PC's are assembled from diverse components, thereby encouraging small manufacturing operations to enter the market, sometimes on a local scale. Because of this factor, PDA hardware tends to be much more uniform than that of PC's, and this, as described below, makes it much more feasible to employ usage control mechanisms in the PDA domain than in the PC domain.

Another important distinction for the PDA domain is that, unlike PC users, users of PDA's generally restrict their use to a single PDA, since the PDA is highly mobile, goes with them wherever they go, and can be used conveniently while sitting, standing, or walking. Although PDA's are designed to be used in conjunction with, and as supplements to, PC's (and some PDA software is available to operate on PC file data), the PDA generally excels in handling real-time information (for scheduling and reminders, ad hoc numerical computation, storing and retrieving memoranda, maintaining personal expense records, e-mail messaging, and so forth), rather than file-based data (such as documents, drawings, presentations, large databases, spreadsheets, and the like) for which the PDA is generally handicapped by a relatively primitive and rudimentary user interface. Connectivity between a PDA and a PC is usually accomplished by means of a connecting cable and synchronizing software in the PC. Some PDA's are also equipped with modems and cellular transceivers for connecting directly to data networks. Most PDA's also have built-in infra-red data links for convenient and very rapid wireless connection (“beaming”) to other PDA's or compatible data devices. Because PDA software applications are typically much smaller in terms of code size than those of PC's, PDA software is almost exclusively distributed via networks, such as the Internet. In addition, it is relatively fast and easy to copy software applications from one PDA to another, such as by the wireless infra-red data link. For this reason, the problem of unauthorized copying and distribution is especially acute in the PDA domain. Fortunately for PDA software publishers, however, manufacturers of PDA's foresaw this problem and provided standardized means for usage restrictions based on the specific PDA (such as through a serial number) or the specific configuration of the PDA (such as through a name or label entered by the user to identify the PDA). It is relatively easy, therefore, for a software publisher to employ usage control to restrict the operation of a particular instance of a PDA software application to a specific PDA (such as that having a given serial number) or to a PDA having a specific configuration (such as that having a given user-entered PDA name). Because the hardware environment and operating system of PDA's is relatively arcane in comparison to that of the PC, and software utilities are less commonly available for PDA's, a small amount of obscurity is generally adequate to protect the usage control mechanisms employed by PDA software publishers. In addition, the relatively small cost of PDA software (in many cases only a few dollars for a PDA software application) serves to reduce the incentive to attack the usage control. As a result, unauthorized copying and distribution does not appear to be a serious problem for PDA software.

### Prior-Art Software Personalization Schemes

The concept of personalizing software is also present in the prior art, although previously it has not been seriously considered as a means of protecting software, and has therefore been inadequately implemented. Prior-art implementations of software personalization consequently suffer from a number of fundamental limitations, as are discussed below. Note that the concept of software personalization as developed herein is distinct from the concept of “customizing”, which herein denotes configuring or adapting the functionality and appearance of software to suit the individual preferences or functional requirements of a user. Processes for customizing software are carried out purely for the convenience of the user and offer no protection to the software against unauthorized copying and distribution. It should be noted that some software publishers refer to software that has been customized for a particular user as software that has been “personalized” for that user, but in using the term “personalized”, they mean to describe software that has been configured or adapted to the preferences or functional requirements of the user, rather than software that is protected against unauthorized copying and distribution, which is the sense of the term “personalized” as used herein.

The basic idea in software personalization is to associate some personal information of the authorized user with the software, principally with the aim of imparting some degree of protection to the software (in the prior art, personalization is assumed to impart only a minor degree of protection, as discussed below). The theory behind personalization of software is that users understandably have no interest or motivation to protect an anonymous and impersonal piece of software from unauthorized copying and distribution. This is true even when the authorized user is associated with a serial number on the software. However, by putting the authorized user's name and perhaps other personal information on the software through a process of personalization, it is herein put forth that the authorized user will thereby acquire an incentive to exercise some measure of care for the software, and will be hesitant to make and distribute unauthorized copies of such personalized software through which he or she is personally identified. At the very least, even though there is nothing to prevent users from making and distributing unauthorized copies, it is maintained that they will be more cautious and limited in their casual copying if the software is personalized than if it is not personalized.

There is considerable merit to the concept of personalization, but the full advantage of personalization cannot be achieved by prior art techniques. Unlike other protection schemes, personalizing software does not incur any significant cost, need not interfere with the operation of the software, and need not involve any ongoing inconvenience to the user. Moreover, to the user, personalization is simple, easily-understood, unobtrusive, inoffensive, and can have positive connotations to the user. Software that is personalized in a manner that is respectful of the user can convey to the user a measure of acknowledgement, recognition, and trust as a valued authorized user.

In contrast to copy-protection, usage control, and identification and tracking schemes, personalization is low-key and not overtly restrictive of the user. It is the heavy overt restrictions and implicit mistrust of the user in copy-protection, usage control, and identification and tracking that are responsible for strong user hostility to these measures, and which effectively challenge attackers to defeat them even in the absence of any financial gain. Despite the fact that users generally must agree that legal ownership of the software remain with the software publisher and that users thereby acquire only a conditional license, users instinctively feel that by purchase and possession of tangible materials (such as media, instruction manuals, etc.) they have, or are entitled to have, some sort of “ownership” in the software, even if only in a limited sense. In particular, users feel that they are, or should be, entitled to make copies of the software for non-commercial purposes. There is no legal validity to this feeling, but it is a widespread and natural sentiment nonetheless, and is a major motivation for the casual copying of software. This feeling also underlies the general resentment of users toward technical measures that restrict their exercise of what they perceive as their legitimate rights. Except in the limited cases of usage control for expensive software in specialized markets, copy-protection, usage control, and identification and tracking are generally not worth the cost and market liabilities when measured in terms of their effectiveness. On the other hand, software that is distributed without any protective measures at all is readily considered by users to be in the public domain, and easily confused (perhaps consciously and deliberately) with the large and growing amount of software that is explicitly distributed free of charge (generally referred to as “freeware”). The only protective measure that is inherently capable of striking a reasonable balance between asserting the software publisher's proprietary rights and respecting the feelings of the legitimate user is personalization of the software.

As discussed below, this potential is not currently realized by existing prior-art techniques, which are bound to the modes of the current physical distribution channels. It has been previously noted that network distribution of software is currently perceived for the most part as an electronic counterpart of physical distribution. As such, prior-art network software distribution also fails to realize the potential of personalization for enhancing the protection of software.

Software personalization is very common during the prior-art setup process, as illustrated in FIG. 2. In a step 202 the customer runs the setup program. In a step 204 the setup program may optionally request the customer to enter a software key. In this case, the customer enters the software key in a step 206. For personalization, in a step 208 the setup program may ask the customer to enter some personal information into one or more fields. In this case, the customer enters the requested information in a step 210. Typically, personal information of this sort includes the customer's name and company affiliation. Because current software distribution is based on a given fixed release (build version) of the software, this personal information is usually written by the setup program into a separate configuration file 216 rather than into the executable software module 218, which is installed by the setup program in a step 214. Although configuration files (including the operating system database) are commonly used today to store setup parameters, in earlier prior-art software, these parameters were sometimes inserted directly into the executable module. In any event, taking note of the process of prior-art software distribution (FIG. 1), it is readily seen that software personalization cannot be done during manufacture of the software, and must be done during setup with steps that usually involve customer interaction (FIG. 2).

Prior-art personalization during setup, as detailed above and illustrated in FIG. 2 is not fully effective as a means of protecting the software from unauthorized copying and distribution. There are a number of weaknesses that stem from sending the customer unpersonalized software that is to be personalized only during subsequent setup:

The customer can make and distribute unauthorized copies of the pre-setup unpersonalized software, which has no protection at all.

Alternatively, the pre-setup unpersonalized software need not even be copied, but simply installed at multiple locations. Currently, most software is distributed on read-only optical media (such as CD-ROM), and cannot be marked or modified by the setup program as having been installed, as was previously possible with magnetic media.

Even if the software is installed by the setup program and thereby personalized, there is no assurance that the customer entered valid personal information. If the customer enters bogus personal information when requested by the setup program, this will result in a software personalization that has no relation to any actual person.

In some cases, the setup program retrieves personal information about the customer from the operating system. Although this does not involve direct user interaction, the other disadvantages noted above remain: the pre-setup unpersonalized software may still be copied, and the software can still be installed in multiple locations. Moreover, the operating system has only whatever personal information the customer may have entered during setup of the operating system. A user who wishes to put a bogus personalization on a software application during such a setup procedure, need only enter corresponding bogus personal information into the operating system.

In all the above cases, either the prior-art software personalization itself is circumvented, or the result is a software personalization that has no relation to any actual person. In either case, the protection potentially afforded by software personalization is lost, and the deterrent effect of software personalization goes unrealized by these prior-art procedures.

To overcome these limitations, some software publishers prepare an individual software key which is cryptographically related to certain personal information supplied by the customer as part of the licensing process. Such a software key can be thought of as a personalized software key. For example, the “WinZip” software application, published by Nico Mak Computing, Inc., Mansfield, Conn. is a product for which such a personalized software key is given to the customer. The entering of personal information during setup is then accompanied by a request to the customer to enter this software key. Both this personal information and the related software key must be entered by the customer during setup in exactly the form as supplied by the software publisher. Otherwise, if the personal information does not cryptographically match the software key, the software or the setup program may be designed to be inoperative. Because the normal method of payment for the software license is through a credit card or other verifiable means, the software publisher can have some degree of confidence that the obtained personal information reasonably represents the intended customer. The intent of having the personalized software key cryptographically related to the personal information is that the customer not be able to alter the personalization of the software. Unfortunately, however, the requirement that the customer enter this personal information and software key during setup places stringent restrictions on the length and complexity of the software key, with the result that the software key has very weak security from a cryptographic standpoint. Many personalized software keys for popular software applications (including the “WinZip” software application mentioned previously) have thus been broken, and many “key generators” (programs for generating software keys, including such personalized software keys) and pseudo-anonymous software keys generated thereby have been published on the Internet, with the result that users can readily alter the prior-art personalizations of software applications.

There are thus available unauthorized copies of software applications with anonymous material in place of the personal information intended by the software publishers. For example, in unauthorized copies of some software applications that are intended to be personalized, the user's name appears as “NoBoDy!”, as “SoMeBoDy!”, or as nonsense letters. The existence and availability of unauthorized copies with such bogus personal information are an indication that authorized users are indeed generally reluctant to distribute unauthorized copies containing actual personal information, and this tends to confirm the concept of software personalization as an effective deterrent to unauthorized copying and distribution. Prior-art techniques of software personalization, however, are not adequate to utilize the full potential of the concept, as noted above.

### Summary of Fundamental and Prior-Art Limitations

It can readily be appreciated that no existing scheme has achieved widespread success in preventing unauthorized copying and distribution of software, and in fact there is reason to believe that there never will be a fully satisfactory solution to the problem of such unauthorized copying and distribution, especially in the case of low-cost software. The fundamental limitation in any scheme of software protection is that software is by nature impossible to hide. In any piece of software, the entirety of the code and data is available for inspection, and can be read, analyzed, and modified. Thus, because nothing in software can be truly secret, software protection cannot obtain cryptographic levels of security, and ultimately must depend on various measures involving mere obscurity. This is not to say that certain aspects of software protection cannot readily benefit from cryptographic techniques, nor is it to say that obscurity affords no protection at all. But it must be kept in mind that in the overall picture, there are limits to what software protection can accomplish. Judicious cryptographic measures in conjunction with well-diffused and systematically alterable obscurity can heavily multiply the effort needed to defeat the software protection, and if the software protection is applied in a deft manner toward realistic goals, the gains of an attacker in defeating the software protection will be greatly outweighed by the time, cost, and difficulty of doing so.

Therefore, although it appears to be impossible to absolutely prevent unauthorized copying and distribution, it is possible to employ effective software personalization to discourage or deter unauthorized copying and distribution and thereby reduce the volume and impact of unauthorized copying and distribution, particularly in the case of special situations that lend themselves to certain approaches to software personalization.

Moreover, because of the exponential growth in distribution of software over networks, particularly the Internet, protection of software based on physical media and hardware keys is of decreasing importance and interest, and alternative techniques for protecting software are needed. Novel alternative techniques are also now feasible because of previously-unavailable capabilities offered by the new network environment and distribution channel.

There is thus a widely recognized need for, and it would be highly advantageous to have, a way of discouraging the unauthorized copying and distribution of software that does not depend on physical media or on user interaction during a setup process, and which has an improved basis for true cryptographic security. These goals are met by the present invention.

### Definitions

Some terms as used herein to denote aspects particularly related to the field of the present invention include:

authentication—any process by which information is prepared, converted, and/or packaged with additional information to allow subsequent proof of the identity of the source, and proof that no unauthorized alterations have been made to the information. The term “authentication” also denotes the results of preparing, converting, and/or packaging information by such a process. Any complementary process for analyzing the authentication to prove the identity of the source and the integrity of the information is denoted herein by the term “validation”, which also denotes the results of such a process.

build—the act of producing deliverable published software, such as through compiling and/or assembling and/or interpreting and/or linking one or more source modules into one or more executable modules of software. This term is also used in the art to refer collectively to the deliverable published software resulting from such a process.

class (of computer)—a type or classification of computer based on software executing capabilities. Non-limiting examples of computer class include computers capable of executing software for various versions of the Microsoft “Windows” operating system., “Unix” computers, and so forth.

compiling/assembling/interpreting/linking—any step or set of steps that results in the production of one or more executable modules from one or more source modules.

computer name—any assigned information which may be used to distinguish one computer or similar device from another. Non-limiting examples of computer names are character strings and serial numbers. A variant of a computer name is a “user name”, which is any assigned information which may be used to distinguish one computer configuration from another. In the case of personal digital appliances (PDA's), the computer name is sometimes referred to as the “user name” or simply the “user”. In this case, care must be used to make a distinction between the term “user” as applied to refer to the computer name, and the term “user” to refer to the human that employs the PDA.

configuration—a state characteristic of a computer, including but not limited to parameters such as processor serial number, computer name, particulars of the hard disk partitioning, directory structure, the operating system registry, user associated with the computer, and so forth. The configuration of a computer may be modifiable by the user for functional purposes, and may also serve to distinguish one computer from another for identification and usage control purposes, such as via a discriminator in a software application.

configuration file—any file containing data and substantially lacking executable code, and which is used as input to software for setting operating parameters or modes thereof. An operating system registry is considered to be a configuration file according to the present invention.

copy-protection—any method or system which attempts to prevent the unauthorized copying and distribution of software, or which attempts to render an unauthorized copy unusable.

customer—any actual or prospective authorized user of software who has received or who is intended to receive a license to use the software.

data—any machine-readable information which can be accepted for input to software, with the explicit exclusion of software itself.

deliverable published—software any published software in a form ready for installation or use by a user, prior to setup, installation, or modification by the user.

disabling—any act which prevents software from being loaded or from being executed, or which causes a program termination of the software.

discriminator—any piece of data or information which can associate software with a particular computer or a particular computer configuration. Discriminators are used in conjunction with usage control to restrict use of the software to the particular computer with which the software is associated. The discriminator is often related to the computer name of the particular computer (including a serial number). Discriminators are always distinct from the user and the user's name, although in cases where there is a superficial similarity between the user's name and the computer name, a discriminator may likewise bear a superficiality to the user's name. Despite this, however, a discriminator is never fundamentally related to a person, and is not considered personal information.

executable module—any component of software which contains program instructions or code that can be loaded into a computer and executed. Executable modules according to the present invention include program units commonly known as “applets”, “macros”, “scripts”, and runtime library files, which may or may not be independently executable, but which nonetheless contain code which may be executed in some fashion. This category also includes, but is not limited to, software containing intermediate, or “pseudo-code” that may be executed via an interpreter or “virtual machine”, such as a Java Virtual Machine. This category further includes, but is not limited to, collections of executable code contained in archive files, such as compressed Java archive (*jar) files, and any such archive files containing substantially executable code are considered as executable modules for purposes of the present invention. Executable modules, however, are distinct from ancillary units of the software which substantially contain data rather than program instructions. Such non-executable ancillary units include, but are not limited to, help files, configuration files, resource files, log files, and the like.

executing—any act of making software operational or conditionally operational to accomplish a task, also referred to as “running” the software. Software that has been executed may not necessarily accomplish a task, however, if the software is in a “standby mode” awaiting activation and is not given further commands or input.

file—any unit of machine-readable data or software that may be stored, retrieved, or manipulated by an operating system or a software application.

fundamentally related—a term denoting a basic relationship that does not depend on arbitrary choices in assigning computer names. Specifically, a computer name is not fundamentally related to any person who is the user of the computer, even if that person assigns a computer name superficially or coincidentally similar to his or her own personal name.

information stream—any set of symbols, wherein each symbol has a unique “address” (or “location”) within the set. A “symbol” is any elementary unit of information, including, but not limited, to characters or numbers. Non-limiting examples of symbols include binary digits (“bits”), ASCII characters, and sequences of binary digits such as “bytes”. Non-limiting examples of information streams include: linear sequences, in which the address of a symbol may be the index of the symbol within the sequence; and complex structures (such as files or sets of files) in which the address of a symbol may constitute several distinct parts (e.g., a file name and the location of the symbol within the specified file). An information stream may be recorded on media or transmitted via a communication system. Software is embodied in an information stream of some sort, wherein the executable modules thereof constitute blocks of associated symbols herein denoted by the term “code blocks”. Furthermore, source modules from which the executable modules may have been derived, as well as the program components of the source modules, may also constitute distinct code blocks within the information stream. Deliverable published software may be delivered to a user such as by downloading the information stream associated therewith to the user over a network, or by recording the information stream onto media and physically delivering the media to the user.

loading—any act of reading software or components thereof from an information stream and writing to the active memory of a computer. For most information streams, it is necessary to “load” the software into active memory in a loading step in order for the software to be operational. A loading operation is normally followed automatically by the execution of the loaded software.

manufacture—the act of recording software onto media to make an original authorized copy of the software, such as by a software publisher.

media—any material for physical storage of software in machine-readable form, internal or external to a computer, and including, but not limited to passive magnetic media (such as hard disk, floppy disk, tape); passive optical media (such as CD-ROM, DVD); passive paper media (such as punched tape or punched cards); or active electrical devices (such as plug-in cartridges containing ROM, PROM, or other such devices).

module—any software component which may be stored, retrieved, manipulated, or loaded by an operating system, or during a build.

operating system—software that provides an environment in a computer for loading and executing other items of software, such as for managing data input to and output from such software, interfacing with other devices (including networks and other computers), and interfacing with human users. Non-limiting examples of popular operating systems include Unix and Windows.

output—any data emanating from or produced by a software application, such as an output data stream or output file. Output can subsequently be used as input to software.

personal information, also denoted herein as “pre-existing personal information” —(pertaining to software) any information having a relationship or association with the user that pre-existed prior to the software build, and excluding data that would be subsequently associated with the user upon or after the software build.

personalization—any process of incorporating personal information associated with a specific user into software or data. The term “personalization” also denotes the personalized portion of the software or data resulting from such a process.

program component—a logical or functional sub-unit within a source module, including, but not limited to data blocks, procedures, and functions.

program termination—any act of stopping the execution of software, as may be done in non-limiting examples, by the user, the operating system, or by the software itself. Program termination is also known as “exiting” or “program exit”. Under normal conditions, immediately after program termination, control of the computer is returned to the operating system. Program termination can be done at any time after execution of the software has begun, including immediately upon starting execution of the software.

published software—any software which is offered to the general public or any sector thereof in substantially identical functional form. Published software excludes specialty software developed by, for, or on behalf of a user for exclusive personal or in-house use, which is proprietary to that specific user, and which is not made available in substantially the same functional form to the general public or a sector thereof. The term “functional form” herein denotes the appearance and behavior of the software to the user at run-time, independent of any binary form which the software may take.

setup—any procedure for installing, configuring, adapting, or customizing software to operate on a particular computer. Setup is generally necessary for software because software usually involves a number of separate “modules”, typically in the form of files, and these must sometimes be copied to different places within the target computer. In addition, these files are sometimes supplied in compressed format and require decompression in order to be usable, and this operation is accomplished during setup. Furthermore, certain operating system parameters may need to be adjusted for the software to function properly, and this is also performed during setup. Setup is often performed automatically via a “setup program”, although manual setup may also be possible for certain software. Setup can also involve more than one computer, such as in the case of a personal computer used to install software on a personal digital appliance.

software—any machine-readable or machine-storable code containing executable instructions for accomplishing or assisting in a task, including source and object code. Software may also contain optional non-executable data, but information consisting exclusively of non-executable data, and having no executable, source, or object code is not considered software according to the present invention. Software is associated with an information stream containing the executable code and ancillary data thereof. Non-limiting examples of tasks performed and assisted by the use of software include information handling and processing; numerical computation and mathematical analysis; automation; problem-solving; locating, tracing, and tracking; planning and design; resource utilization; counting, measuring, and calibration; text display and manipulation; document preparation, printing, and distribution; rendering and visualization; translating; record-keeping and archiving; financial analysis, accounting, auditing, and reporting; sales and marketing; commercial and financial transactions, mediating and escrow; payment, and collection systems; pattern recognition and matching; identification, identifying, and classifying; graphical display and manipulation; audio and/or video display or manipulation; quality-control, quality assurance, troubleshooting, and diagnosis; data acquisition, analysis, storage, retrieval, and processing; error-detection and correction; predicting, forecasting, and estimating; navigation, orientation, and guidance; surveying and mapping; simulation, modeling, and experimentation; timing, time-keeping, and time-recording; production, manufacturing, and laboratory process control; numerical control, fabrication, and assembly; monitoring and alerting; security, surveillance, and access control; organizing and scheduling; education, teaching, and training; testing and evaluating; administration; development, modification, and maintenance and other software; communication; entertainment and amusement; and operation of a computer for loading, controlling, and interfacing with other software (known in the art as an “operating system”). Software is generally installed into an internal storage device of the computer (such as a hard disk) and is then loaded into the computer's memory for execution. Software, however, may also be recorded on removable media (such as floppy disk, CD-ROM, or tape) and be loaded directly therefrom. Software may also be resident in some form of active memory (such as ROM or flash memory) and may be ready-to-operate without needing a separate loading step. The term “software” denotes any executable module or any information from which an executable module may be derived, and is distinct from data.

software application—any distinct unit of software. In addition to the software units commonly referred to as “applications”, which are characterized by their ability to perform tasks of interest to a user (including, but not limited to, tasks such as word processing, spreadsheets, graphics, and the like), the term “software application” herein denotes any unit or instance of software, including, but not limited to, software units commonly referred to as “applets”, “scripts”, “macros”, “utilities”, “diagnostics”, “development software”, and “operating systems”.

software protection—any action, strategy, device, system, procedure, or technique that is intended to protect proprietary rights of the software publisher. In this context, the terms “protect”, “protecting”, “protected”, and “protection” is also used herein to refer to software protection.

software publisher—any person or organization that creates, markets, publishes, distributes, licenses, holds, sells, or otherwise furnishes software, and claims for itself or on behalf of others any proprietary rights to such software, including, but not limited to: any rights of ownership in the software, rights to distribute the software, rights to license use of the software, and rights to restrict the use of the software. The term “software publisher” as used herein also denotes entities commonly designated as “retailers” and “distributors” of software.

source module—any unit of software constituting primary (“source”) or intermediate (“object”) code that logically corresponds to an executable module of deliverable software. Source modules include, but are not limited to:

modules written by a human programmer in an available programming language (non-limiting examples of which include C++, Basic, Java, and assembly language), and which are ready to be compiled or assembled into one or more executable modules, or which are ready to be interpreted from one or more executable modules; and

modules that have been compiled or assembled as appropriate, and which are ready to be linked into one or more executable modules.

Note that, although executable modules may be derived from source modules, there is not necessarily a one-to-one correspondence between source modules and executable modules. Typically, there is more than one source module corresponding to an executable module.

usage control—any method or system which attempts to restrict the operation of software, such as to a specific user, a specific computer, or a specific hardware accessory, or any restriction as to the number of times or the duration of time during which the software may be operated. Usage control thus involves imposing one or more specified and well-defined “usage restrictions” on the functioning of the software.

user—any person or organization which obtains, attempts to install, or attempts to operate on a computer a given item of software. Generally, legitimate users obtain a license to use the software from the software publisher, and are thereby authorized users of such software.

### SUMMARY OF THE INVENTION

The present invention provides for software that already contains embedded pre-existing personal information related to the authorized user prior to delivery to the authorized user, such that the authorized user has a personal incentive to protect the software from indiscriminate unauthorized copying and distribution.

It is an object of the present invention to provide a means for personalizing software in a way that pre-existing personal information associated with the authorized user is already present in the software at the time of delivery to the user, prior to any setup required to install the software in the user's computer.

Moreover, it is an object of the present invention to make it unfeasible for an attacker to alter or remove the personalization from the software, and to render software without such personalization incompatible with authorized copies of the software that have a valid personalization.

It is furthermore an object of the present invention to allow the personalization to be extended, where possible, to data output by the software, and to make it easy to view the personalization associated with the software and the output data, while at the same time keeping the personalization respectful of the user, as well as unobtrusive, non-offensive, and non-threatening to the user. It is also an object of the present invention that the incorporation of a personalization into the software application produce no side-effects that could adversely affect the operation of the software application.

It is additionally an object of the present invention that the protection afforded by the personalization neither be associated with any usage restrictions nor activate any usage restrictions, so that deliverable published software protected solely by the personalization be operational in substantially identical functional form at all times, all places, and for unrestricted use. In particular, it is an object of the present invention that the personalization be unrelated to any specific computer or any specific configuration of a computer, such that deliverable published software protected solely by the personalization executes in substantially identical functional form on substantially all computers belonging to the class of computer for which the software has been developed or is intended to execute. In other words, it is an object of the present invention that the inclusion of a personalization itself does not interfere with any normal operation of the deliverable published software containing the personalization, and that the personalization itself not be used in conjunction with any usage control.

### Differences from the Prior Art

The distribution process according to the present invention differs significantly from that of the prior art (as illustrated in FIG. 1). FIG. 3 illustrates the overall order fulfillment process for delivery of personalized software to a customer, according to the present invention. In a step 302 the software publisher receives an order from a customer, who concurrently supplies customer personal information 304 as part of the ordering process. At the very least, customer personal information 304 will normally include the name of the customer. At a decision point 306, if the customer personal information is not verified, the order is rejected in a step 308. If, however, the customer personal information is verified, then customer personal information 304 is input along with source modules 310 to a build step 312, which results in the output of personalized executable modules 314, which constitute the deliverable software, and in a step 316, personalized executable modules 314 are delivered to the customer. What is necessary for verification of the customer personal information at decision point 306, however, is left to the discretion of the software publisher, so that the operation of decision point 306 is under control of the software publisher, and may be omitted.

As noted, the procedure described above and illustrated in FIG. 3 is distinctly different from prior-art order-fulfillment for published software as illustrated in FIG. 1. Currently, software builds for published software are completely independent of any specific customer or customer personal information. Indeed, the procedure of FIG. 3 is completely impractical for traditional distribution channels, which rely on physical distribution of software recorded on media. Not only would pre-manufacture personalization of the software eliminate the economy of large-scale manufacture and make the software manufacturing process very costly, but management and delivery of the personalized software would become time-consuming and prohibitively difficult. These restrictions and limitations, however, are not necessarily present when the software is ordered and delivered via an interactive network, such as the Internet. In many instances today, for example, a customer can select and order software via the Internet, and receive the software almost immediately via a download during the same Internet session. There is no fundamental factor to prevent a server involved in this process from also performing a build during the time of the session, whereby the customer personal information would be integrated into the deliverable executable modules that would be downloaded to the customer, as described above and illustrated in FIG. 3. This is a capability of the network distribution channel that is not currently exploited by prior-art distribution processes, but which is utilized by the present invention.

Not only does pre-delivery personalization of the software overcome many of the limitations of prior-art personalization as applied by the user during setup, but a number of unexpected benefits result therefrom:

First, personalization of software during the build process allows the use of cryptographic keys that offer improved authentication and security. In contrast to prior-art personalization applied incidentally by the user during setup, where keys are necessarily short (and therefore weak), personalized cryptographic keys automatically integrated into the software during build according to the present invention can be as strong as desired. This is very important, as it is the only way of embedding true cryptographic-level security into a software protection system. By using well-known techniques of public-key cryptography, it is possible to enhance the protection of software through personalization in such a way that the software has access only to public key information and has no access to information about the private key used to authenticate the personalization. There are various ways software may have access to a key, including, but not limited to, containing that key as data, containing that key in the form of executable instructions, and having an associated file containing that key as data. Regardless of how the software code itself may be scrutinized and understood by an attacker, then, the crucial private key information can remain securely hidden and safe. An attacker might be able to read and modify the software code, but with strong cryptographic measures in place, no attacker would ever be able to produce a bogus personalization, as is commonly done today with prior-art personalization schemes.

Second, because strong personalized cryptographic authentication and security can be integrated into the software, output from the software can securely carry the personalization as well, where applicable. Other authorized copies of the software can cooperate in enforcing the protection, such as by being programmed to accept input only from an authorized copy which places a valid personalization in the output therefrom. Communications software, for example, can be programmed to allow connection only to authorized copies of the software that have a different personalization, and the personalizations can serve to authenticate the communicating parties to one another. As another example, output files passed among many users and processed by them can accumulate a record of the users by appending the personalizations. This increased visibility of the personalizations, if presented properly by the software, can serve to increase the sense of both responsibility and security of the users, and can make it difficult for a version of the software that an attacker has modified (in order to remove the personalization) to function in such an environment.

Third, detailed customizing is possible with the order fulfillment process as described above and illustrated in FIG. 3. Because the software is being built expressly for the current customer, it is possible to offer the customer a number of options at the time of licensing, and to base the cost of the license on only the selected options.

Fourth, in some development environments, it is possible to permute the order of source modules used in the build. The resulting software instances are functionally identical, but can differ radically in their binary form (the machine code), and this factor can enhance the protection afforded to the software. Varying the binary form (machine code) structure from one instance of the software to another in this manner can make it extremely difficult for an attacker to prepare a general-purpose program for modifying different instances of the software. Whereas an attacker might be able to determine the locations and functions of the component routines of a single instance of the software, this effort would be applicable only to that specific instance, and he would have to repeat the work to do this for another instance. Thus, unauthorized modifications of the software would be extremely hard to automate. Instead of isolated obscurity, then, such an approach offers a systematic permutation of the elements of the executable module from one instance of the software to another.

It should be noted that while a personalization according to the present invention can be authenticated by the use of a digital signature, the goals and processes of applying a personalization are completely distinct from those of authenticating the software itself (such as for Java-based software, as previously discussed, which results in a “signed software application” or “signed archive”). As already detailed, the goal of authenticating software (such as a Java software application or archive) is to protect the user from possibly-malicious effects of untrusted software, and the process of doing so basically involves only the applying of a digital signature to the software and the subsequent validation thereof at run-time, according to well-known methods of public-key cryptography. In contrast, as disclosed herein, the goal of applying a personalization to software, with or without authentication, is to protect the software itself (and the software publisher who developed the software) by affording some degree of protection against unauthorized copying and distribution. Moreover, the processes of applying a personalization, as detailed herein, involve novel methods that are different from the mere application of a digital signature, although digital signatures may be used as part of these processes to protect the applied personalization against tampering and forgeries.

### Differences Between a Personalization and a Discriminator

It is to be emphasized that the personalization of the present invention differs fundamentally in several important ways from a prior-art discriminator employed in conjunction with a usage control mechanism, such as that for a PDA. In order to impose usage restrictions on software, software publishers sometimes associate the software in some manner with a specific computer, or with a specific computer configuration. The aim of this is to restrict the software sold to a particular customer to use on a particular computer, and thereby deter unauthorized copying and distribution, because any unauthorized copies would not be usable on other computers. As noted earlier, this is often done with PDA software, where the association of the software with a particular PDA is done via a serial number of the PDA or via a computer name given to the PDA by the user. The term “computer name” herein denotes any assigned information which may be used to distinguish one computer from another. A variant of a computer name is a “user name”, which is any assigned information which may be used to distinguish one computer configuration from another. In the case of PDA's, the computer name is sometimes referred to as the “user name” or simply the “user”. In this case, care must be used to make a distinction between the term “user” as applied to refer to the computer name, and the term “user” to refer to the human that employs the PDA.

In some cases, computer names are preassigned by the manufacturer (e.g., built-in serial numbers), and in other cases, computer names may be assigned by the user, in which case the computer name is part of the configuration of the computer. In some cases, computer names are intended to be permanent, whereas in other cases the computer name assigned to a particular computer may be changed. Computer names include, but are not limited to, character strings and numbers. The term “discriminator” herein denotes any piece of data or information which can associate software with a particular computer or a particular computer configuration, including, but not limited to, serial numbers and computer names. It is noted that discriminators are well-known in the art.

In some cases, a user can assign a computer name that happens to be similar to, or is superficially connected with, the user's own name or other item of personal information. For example, a user named “John Doe” might assign the computer name “JDOE” to his computer. Because PDA's are intended for the exclusive personal use of a single user, the distinction between the user himself or herself and the PDA is often blurred as far as software applications are concerned. The result of this is that the distinction between the user's name and the computer name is also often blurred. This effect is seen in some PDA software that refers to the computer name as if the computer name were the user himself or herself. For instance (using the example above), certain PDA software might refer (on-screen in the graphical interface) to the user as “JDOE” despite the fact that “JDOE” actually refers to a device (the PDA itself) rather than to a person (the human who employs the PDA). The distinction between the user's name and the computer name can be seen clearly by realizing that the choice of computer name is arbitrary and need not have any connection to the user. For example, “John Doe” could just as easily assign the computer name “ABC123” to his PDA. In this case, the relevant PDA software would refer to the user as “ABC123”, clearly showing that the software does not actually refer to the human user, but rather to the computer device. For purposes of usage control, software always refers to the computer, rather than the user. In particular, discriminators always refer to computers or computer names, rather than users, even though there might be a coincidental and/or superficial similarity with the user's own name, as illustrated in the above example.

One distinction between a personalization according to the present invention and a discriminator is that a personalization involves personal information related to a specific customer (a human), whereas a discriminator involves information related to a specific computer or configuration of a computer (a device). To emphasize this distinction, it is noted that a personalization is always fundamentally related to a human, whereas a discriminator is always fundamentally related to a computer or similar device, regardless of any coincidental or superficial similarity that may exist. The term “fundamentally related” herein denotes a basic relationship that does not depend on arbitrary choices in assigning computer names. Specifically, a computer name is not fundamentally related to any person who is the user of the computer, even if that person assigns a computer name superficially or coincidentally similar to his or her own personal name. The reason that a computer name is not fundamentally related to the person is that the choice of computer name is arbitrary in the context of assignment (and need not be similar to any person's name for software purposes), and according to the definition of the term “fundamentally related” (as defined herein), this factor disqualifies a computer name from being personal information. In contrast, a person's name is fundamentally related to that person, and thereby qualifies as being personal information. Likewise, personal information such as a person's home address, employer, pre-assigned identification number (such as a social security number, bank account number, and so forth), and any other such pre-existing information, without limitation, that a person might consider to be “personal information”, is considered to be fundamentally related to that person for purposes of definition herein.

Another distinction between a personalization according to the present invention and a prior art discriminator is that a personalization is neither associated with nor activates any usage restrictions, whereas the purpose of a prior art discriminator is to activate usage restrictions as part of a usage control scheme.

Therefore, according to the present invention there is provided, in an information stream associated with deliverable published software from a software publisher to a customer, an arrangement for software protection including a personalization, the personalization incorporated into the information stream by the software publisher and containing pre-existing personal information fundamentally related to the customer.

Additionally, for software intended to execute with substantially the same functionality on substantially all computers of a class of computers, in keeping with the objectives of the present invention, it is provided that the personalization be not fundamentally related to any specific computer and not fundamentally related to any specific computer configuration. It is further provided that the personalization be neither associated with nor activate any usage restriction on the software.

Moreover, according to the present invention there is also provided a method for protecting published software ordered by a customer, the method including the steps of: (a) obtaining pre-existing personal information fundamentally related to the customer; (b) producing, from the pre-existing personal information fundamentally related to the customer, a personal information module; and (c) producing an executable module deriving at least in part from the personal information module and incorporating the pre-existing personal information fundamentally related to the customer.

Furthermore, according to the present invention there is additionally provided a system for protecting published software ordered by a customer, the system including: (a) a personal information collector for collecting pre-existing personal information fundamentally related to the customer; (b) a personalization compiler, for producing, from the pre-existing personal information fundamentally related to the customer, a personalization module; and (c) an executable module builder, for producing deliverable published software containing the pre-existing personal information fundamentally related to the customer and derived at least in part from the personalization module.

### BRIEF DESCRIPTION OF THE DRAWINGS

The invention is herein described, by way of example only, with reference to the accompanying drawings, wherein:

FIG. 1 shows the sequence of prior-art software development and distribution.

FIG. 2 shows the sequence of the prior-art software installation and personalization of software during the setup process.

FIG. 3 is a block diagram of the order fulfillment process for personalized software according to the present invention.

FIG. 4 conceptually illustrates prior-art software development processes and elements.

FIG. 5 shows an embodiment of a source module composition for inserting a personalization into a software application according to the present invention.

FIG. 6 shows an embodiment of a source module configuration for encoding a personalization within a software application according to the present invention.

FIG. 7 illustrates a portion of an information stream and code blocks therein of deliverable published software according to the present invention.

FIG. 8 conceptually illustrates a procedure according to the present invention for using a public key cryptosystem to authenticate a personalization.

FIG. 9 conceptually illustrates a procedure according to the present invention for using a public key cryptosystem to validate a personalization.

FIG. 10 conceptually illustrates a procedure according to the present invention for using a digital signature to authenticate a personalization.

FIG. 11 conceptually illustrates a procedure according to the present invention for using a digital signature to validate a personalization.

FIG. 12 shows the personalization of output files to provide attack-resistant protection according to the present invention.

FIG. 13 shows a Java software application protected by a personalization according to the present invention, and contained within a signed Java archive file.

FIG. 14 illustrates a system according to the present invention for personalizing deliverable published software.

### DESCRIPTION OF THE PREFERRED EMBODIMENTS

The principles and operation of software personalization according to the present invention may be understood with reference to the drawings and the accompanying description. Those knowledgeable in the art will appreciate that the descriptions, drawings, illustrations, and examples presented herein are necessarily general and conceptual in nature, because of the great variety of software languages, methodologies, tools, target platforms, development environments, and production facilities in use today. Accordingly, the descriptions, drawings, and examples given herein are intended as illustrative only, and are not intended to limit the scope of the present invention.

### Software Builds

There exist in the software industry a number of diverse methodologies for producing software. In general, all of these methodologies are usable according to the present invention, but each may have to be adapted to take detailed methodological operation into account. For purposes of describing the present invention in general terms to accommodate all such methodologies, some terms are introduced, which conceptually combine several steps or elements into a single step or single element.

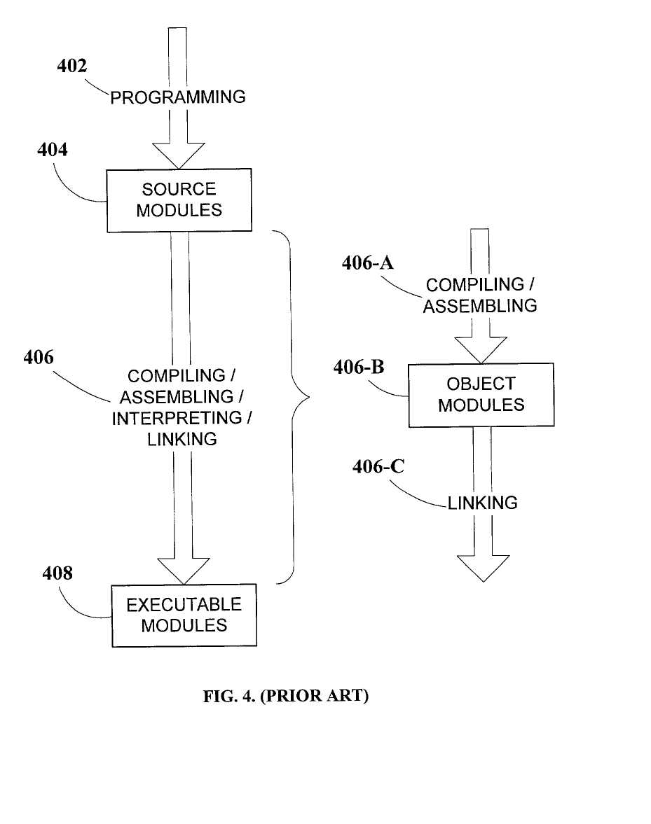

FIG. 4 conceptually illustrates the prior-art software development process. For purposes of the present invention, software development is fundamentally a two-step process with two elements. In a step 402, a human programmer writes one or more source modules 404 in one or more higher-level computer languages (for example, source modules could be files designated as prog1.c, prog2.c, prog.h, and AUX.ASM). Then, in a compiling/assembling/interpreting/linking step 406, source modules 404 are transformed into executable modules 408 (for example, files designated as Prog.EXE and AUX.DLL), which can be loaded and executed on a computer. Note that executable modules 408 could be supplied to the user in modified format (such as in compressed format) for conversion to the installation format by a setup program. However, such aspects and procedures are not relevant to the present invention and are not considered herein. In the case of Java-based software, executable modules 408 could also be supplied to the user in Java archive (*jar) format, in which case the Java archive can be authenticated for validation at run-time, as detailed below.

The great majority of software development environments employ a three-step process for producing software, as illustrated in FIG. 4. In these development environments, compiling/assembling/interpreting/linking step 406 is actually made up of two smaller steps, a compiling/assembling step 406-A, which creates object modules 406-B (for example, files designated as Prog.OBJ and AUX.OBJ), and a linking step 406-C to output executable modules 408. Other software development environments may combine the compiling or assembling steps with the linking step to reduce the process to the two steps. Still other software development environments (such as Java development environments) may include additional steps, such as the preparation of executable modules in archive format. For purposes of the present invention, therefore, no distinction is made between what are commonly referred to in the art as “source modules” and “object modules”, and both are combined conceptually into modules herein denoted as “source modules”, and this term is generalized to include any primary, secondary, or other intermediate units, if any, of software prior to the construction of an executable module, including, but not limited to, units commonly referred to as “source modules” and “object modules”. Furthermore, executable modules also include modules in archive format, such as Java archive format. Likewise, for purposes of the present invention, therefore, no distinction is made between “compiling” or “assembling” and “linking”, nor between these and processes known in the art as “interpreting”. These are all combined conceptually into a lumped process herein denoted as “compiling/assembling/interpreting/linking”, a term that generally includes any procedure which transforms, or aids in the transformation of, source modules into executable modules or which executes or aids in the direct or indirect execution of source modules.

### Types of User Personal Information

Although user personal information is generally understood to be data such as name, company affiliation, and so forth, the type of data acceptable for personalization according to the present invention is not limited to this, but may also include any kind of data with a pre-existing relationship pertaining to the user. Non-limiting examples of other kinds of (pre-existing) personal information include physical address (home and/or business); e-mail address; bank account information; social security number; driver's license number, passport number, and other identification numbers previously assigned to the user, such as by government authorities; name of employer; date and/or place of birth; educational degrees; alternative names under which the user is also known, has been known, or wishes to be known, including, but not limited to: nicknames, former names, pseudonyms, pen-names, stage-names, and other aliases; name of parents, spouse, or other next-of-kin; and audio-visual data such as pictures, videos, voice, biometric data, and so forth. Even though in practice it may be advisable to restrict the nature of such personal information embedded in the software to respect the user's privacy, in principle whatever can be represented by digital data and relates to the user's pre-existing personal and/or business identity may be included as personal information for personalization of software according to the present invention.

It should be re-emphasized that personal information for software as defined herein is limited to data having a pre-existing association with the user prior to the software build, and excludes material which would be subsequently assigned to the user upon or after the software build. For example, although a user's pre-existing social security number is considered as personal information according to the present invention, a previously unassociated serial number that is subsequently assigned to a user upon or after software purchase (such as a customer number), and thus subsequent to the software build, is not considered to be personal information according to the present invention.

### Inserting a Personalization within Software

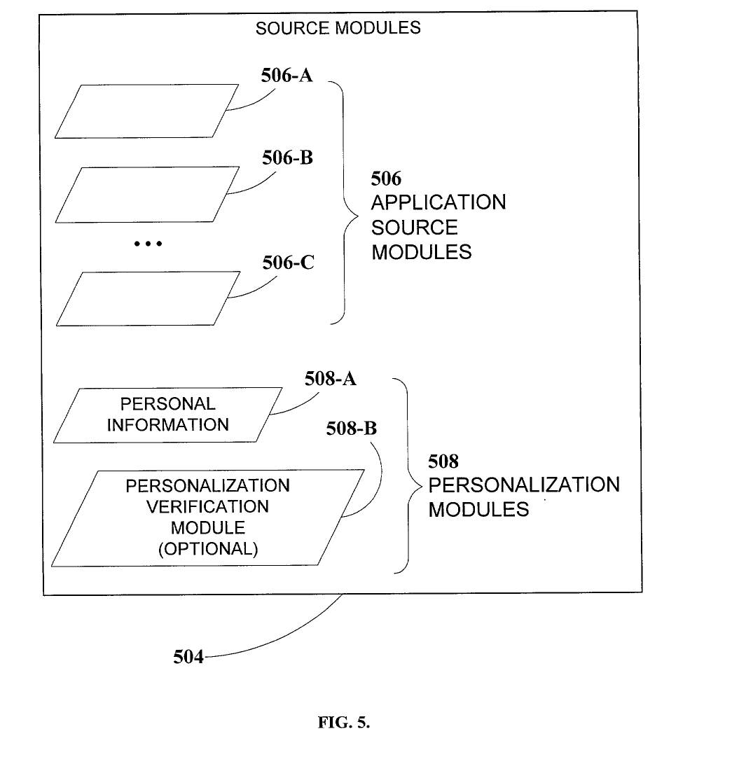

FIG. 5 illustrates an embodiment of the present invention in which personalization modules 508 are inserted into software source modules 504. Software source modules 504 contain application source modules 506, which constitute the source for the executable modules of the software. Illustrated are a source module 506-A, a source module 506-B, and a source module 506-C. The ellipsis ( . . . ) indicates that addition source modules are possible. Personalization modules 508 include personal information 508-A related to a specific customer and an optional personalization verification module 508-B. Personal information 508-A is substantially data relating to the specific customer with no executable code. Optional personalization verification module 508-B, however, contains executable code for verifying, at run-time, the presence of personal information 508-A in the executable module derived from source modules 506. Optional personalization verification module 508-B may be omitted, but if not included in an executable module of the software, the software cannot perform a self-test at run-time to determine if personal information 508-A is present. Extensions of the personalization verification module for a rigorous validation of the personalization are discussed below, under the heading “Authenticating and Validating a Personalization”.

Step 406 (FIG. 4) is performed on the completed software source modules 504 to generate an executable module containing personal information 508-A along with the optional personalization verification module 508-B. According to the present invention, the resulting executable module having personal information 508-A constitutes at least a part of the deliverable published software to the customer whose personal information is contained therein.

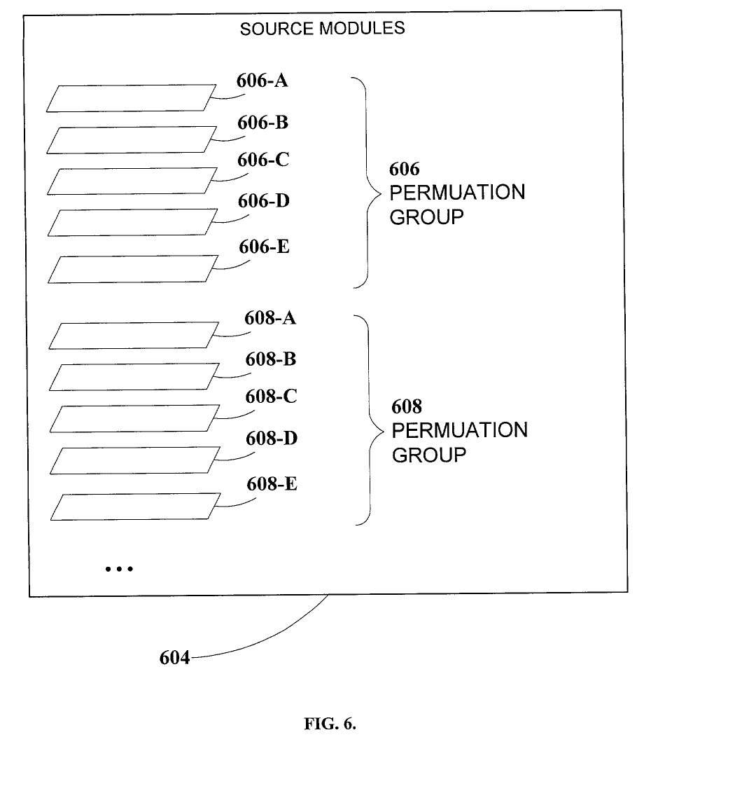

FIG. 6 illustrates another embodiment of the present invention, in which personal information may be encoded into existing source modules (those which the developer of the software has already produced in order to construct the software) without the need to insert additional data. In FIG. 6, existing software source modules 604 are divided into a set of permutation groups, shown as a permutation group 606 and a permutation group 608. The ellipsis ( . . . ) indicates that other permutation groups are possible. Within each permutation group are multiple distinct elements, which, in an embodiment of the present invention, are source modules. In this example, permutation group 606 and permutation group 608 each have five elements, denoted as elements 606-A, 606-B, 606-C, 606-D, and 606-E within permutation group 606, and as elements 608-A, 608-B, 608-C, 608-D, and 608-E within permutation group 608. The elements in each permutation group are selected in such a way that they can be arranged in a number of different permutation orders without affecting the ability to produce a build. For example, elements 606-A, 606-B, 606-C, 606-D, and 606-E within permutation group 606 might be selected to be independent of one another so that their order is irrelevant during a build. In this example, some of the different possible element orderings of permutation group 606 include: {606-A, 606-B, 606-C, 606-D, 606-E}, {606-B, 606-A, 606-C, 606-D, 606-E}, {606-B, 606-C, 606-A, 606-D, 606-E}, {606-B, 606-C, 606-D, 606-A, 606-E}, and so forth. It should be noted that the order in which the elements appear within a permutation group is not related to, and is independent of, the order in which these elements are invoked by the software during execution. The order within a permutation group is related to the respective addresses of the elements within the information stream of the software application. The order in which these elements are invoked by the software during execution, however, is determined by the logical program flow as specified in the source modules. Thus, the arbitrary ordering of the elements with permutation groups has no effect on the run-time operation of the software application.

In many popular development systems, the linking of object modules is the final step of the build process. In the embodiment of the present invention in which the elements are source modules, the selection of element order, then, can be made simply by reordering the link reference list to these source modules that is sent to the linker, and the linker will then produce an executable module according to the specified order in the link reference list. No matter how the order is specified, the different possible arrangements of the elements will be reflected in corresponding variations of the binary form of the executable module, provided, of course, that each element within a permutation group is distinct from all the others.

Alternatively, in many popular development systems, the compiling of source modules is also a step of the build process. Furthermore, within a given source module, there are usually distinct program components (non-limiting examples of which are data blocks, procedures, and functions), which are usually compiled in the order in which they appear in the source module. The order of these program components within a source module is often arbitrary. Accordingly, in another embodiment of the present invention, the elements within permutation groups 606 and 608 are program components, and it is thus possible to encode personal information at the source module level in a manner similar to that previously described for encoding personal information at the object module level. Furthermore, since there are usually many program components within a source module, there are usually many more separate program components than there are source modules, and hence more permutation groups are possible using program components than using source modules. Consequently, the arrangement of elements 606-A, 606-B, 606-C, 606-D, and 606-E within permutation group 606 and elements 608-A, 608-B, 608-C, 608-D, and 608-E within permutation group 608 as shown in FIG. 6 is applicable to permutation groups containing both program components as well as source modules.

A permutation group containing n source modules and/or program components can be arranged in n! different ways. In the example shown in FIG. 6, permutation groups containing n=5 source modules and/or program components can be arranged in 5!=120 different ways, and thus permutation group 606 and permutation group 608 can each encode 120 different symbols, more than the standard ASCII printable character set. Thus, for instance, if there are 500 elements (source modules and/or program components), then it is possible, according to this example, to encode personal information into the executable module containing 100 arbitrary printable ASCII characters without increasing the size of the executable module. To decode this personal information, it is necessary to determine, from the binary form of the executable module, the original orders of the permutation groups prior to the build, and to compare these orders against a table of the characters corresponding to the different permutation orders. Determining the original orders of the permutation groups prior to the build may be done by searching through the binary form of the executable module for characteristic patterns of each source module and/or program component. Such characteristic patterns can be found, for example, in the binary codes for location-independent instructions. These codes are not altered by the linker and therefore characteristic combinations or sequences thereof can be used to uniquely identify the elements (source modules and/or program components) and their relative ordering within the permutation groups. A decoder of this personal information could be incorporated into the software itself (in a source module). In addition, a personalization verification module could also be incorporated into the software itself (in a source module). An advantage of encoding personal information in this manner is that it is extremely difficult for an attacker to remove or alter the personalization, because doing so involves a large-scale rearrangement of the code blocks of the software's information stream. To do this without rendering the software inoperative requires making a large number of precise changes to the internal addressing of the information stream.

As above, step 406 (FIG. 4) is performed on the completed software source modules 604 to generate an executable module containing the encoded personal information. According to the present invention, the resulting executable module constitutes at least a part of the deliverable published software to the customer whose personal information is contained therein.

In yet another embodiment of the present invention, it is possible to combine inserting personal information (as in FIG. 5) with encoding personal information (FIG. 6).

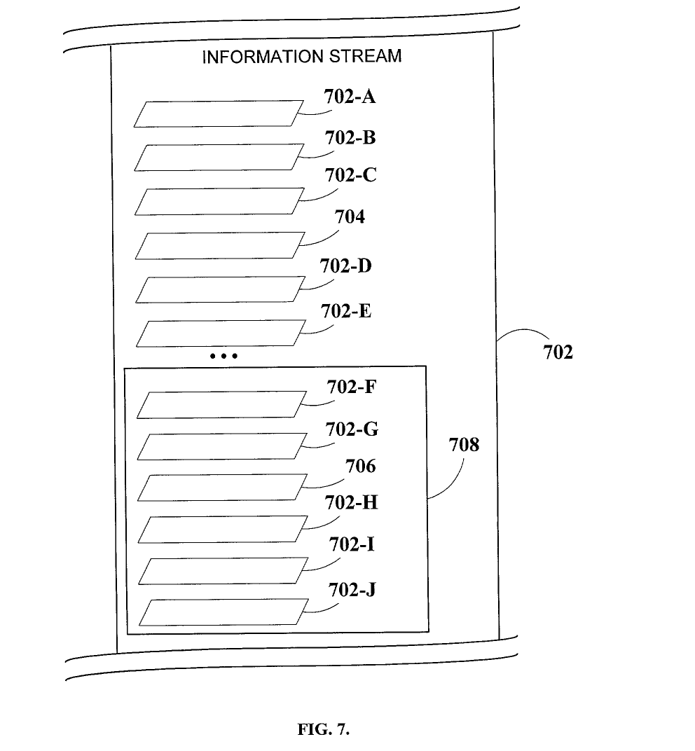

FIG. 7 illustrates a portion of an information stream 702 of deliverable published software of an embodiment of the present invention. Within information stream 702 are code blocks 702-A, 702-B, 702-C, 702-D, 702-E, 702-F, 702-G, 702-H, 702-I, and 702-J, which correspond to source modules of the software application and/or program components thereof. The ellipsis (. . . ) indicates that further code blocks are possible. In addition, information stream 702 contains a personal information block 704 (corresponding, for example, to personal information 508-A in FIG. 5) and a personalization verification module 706. In this embodiment, code blocks 702-F, 702-G, 702-H, 702-I, and 702-J and personalization verification module 706 collectively constitute an executable module 708 of the software application. In another embodiment, though, personal information block 704 could also be incorporated into executable module 708. In yet another embodiment, personal information could be encoded in information stream 702 according to the order of code blocks 702-A, 702-B, 702-C, 702-D, 702-E, 702-F, 702-G, 702-H, 702-I, and 702-J, which correspond, respectively, to elements 606-A, 606-B, 606-C, 606-D, and 606-E within permutation group 606 and elements 608-A, 608-B, 608-C, 608-D, and 608-E within permutation group 608, as discussed above and illustrated in FIG. 6.

Because each instance of the software protected according to the present invention is generated by a separate build and has a unique information stream, there are additional variations which can increase the degree of protection by taking advantage of the potential afforded by the freedom with individual builds. In the previous embodiment illustrated in FIG. 5, personal information 508-A of a particular authorized user is inserted into source modules 504 and, subsequent to the build, appears in information stream 702 (FIG. 7) at an address corresponding to the position of code block 704. The build for a different authorized user need not place code block 704 in the same address in information stream 702. In fact, as previously described in the embodiment illustrated in FIG. 6, it is possible to individually permute the order of the code blocks in each information stream. Even if no information is encoded in permutation groups as illustrated in FIG. 6, it is beneficial to permute the code blocks of the information stream differently for each customer, such as by permuting the program components and/or source modules. In such a manner, in an embodiment of the present invention, the personal information does not have a fixed address within the information stream. Moreover, in yet another embodiment of the present invention, the extent of the personal information is varied at the source module level so that the code blocks corresponding thereto occupy different extents of address space in the information stream. The term “extent” herein denotes not only the net amount of address space occupied, but also the range of address space occupied, because the address space allocated need not constitute contiguous regions. Thus, in embodiments of the present invention, the personal information does not have a fixed address in the information stream, nor does the personal information have a fixed extent in the information stream.

The benefits of permuting the code blocks within the information stream differently for each authorized user, and in particular, in locating the code blocks corresponding to the personal information without a fixed address and/or without a fixed extent in the information stream are realized in the greatly increased difficulty in attacking the protection of the software. This is because many technically-sophisticated attackers disseminate only information about the methods they have discovered for removing protection from software, such as in the form of “cracks” or “patches” (program alterations to the software), but not the unprotected software itself. Users who wish to modify software which they have already obtained (either from a legitimate source or as an unauthorized copy), can then use these patches to remove the protection from the software already in their possession. For example, it is sometimes possible to use such patches to transform software distributed by the software publisher as demonstration programs into fully-functional versions thereof, or to remove other protective limitations. But patches (and other kinds of fixed alterations to software) are ineffective if the published copies of the software do not have fixed addresses and/or fixed extents within the information stream.

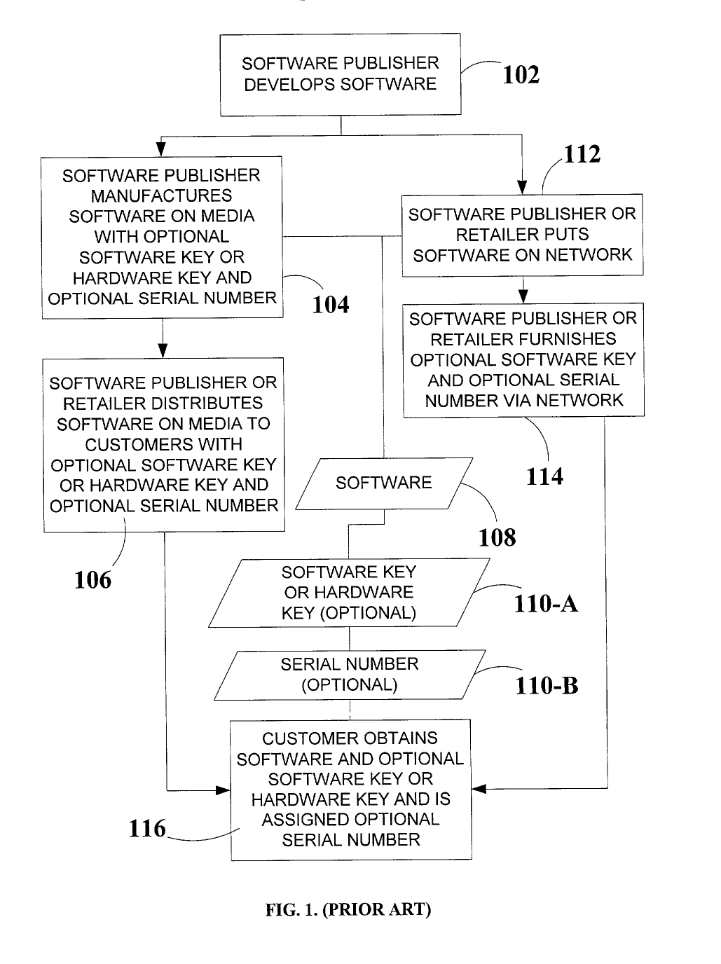

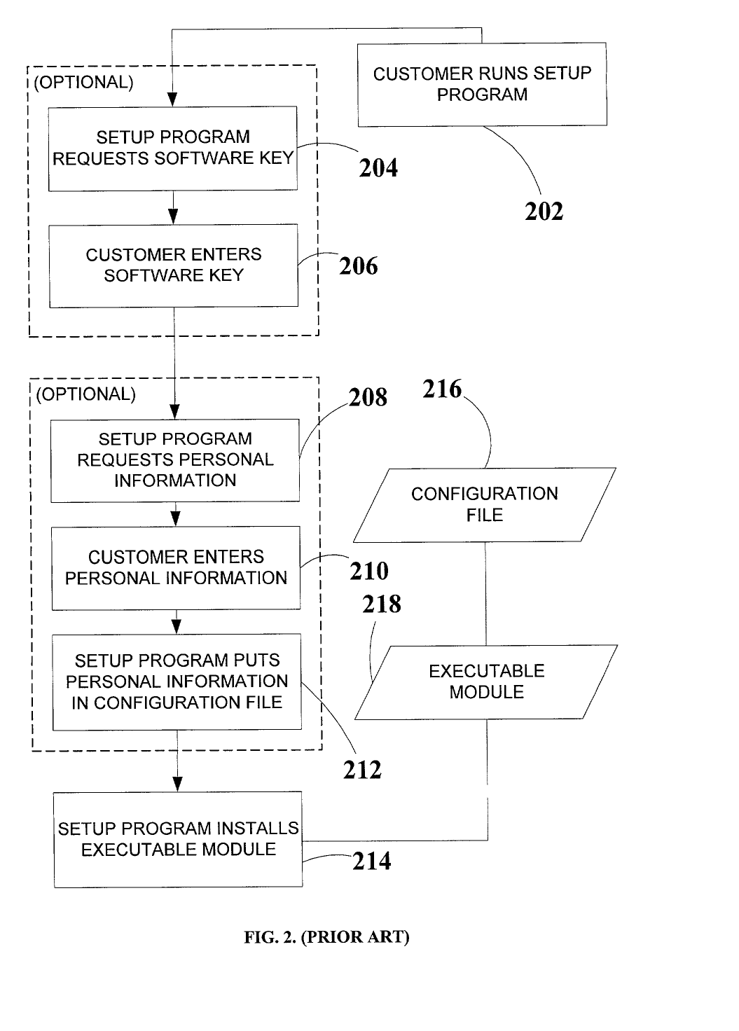

In this fashion, the information stream of the deliverable published software is individually personalized for each customer separately to include personal information of the customer that pre-existed prior to the build of the deliverable published software. It should be noted that this overcomes limitations of the prior art, where (as illustrated in FIG. 1 FIG. 2, and described previously) a customer can be associated with the software only subsequent to the build, either by post-purchase identification with an arbitrary serial number 110-B (FIG. 1) which has no pre-existing relationship with the customer and therefore has no personal significance to the customer, or by setup program request 208 (FIG. 2) over which the software publisher has inadequate and unsatisfactory control.

### Improving the Efficiency of the Personalization Process

As described herein, the present invention provides for incorporating personalized information within the software information stream during the build process. There are several points to note in order to improve the efficiency of incorporating the personalization, so that an instance of personalized software can be produced with the least work, and in the minimum time.

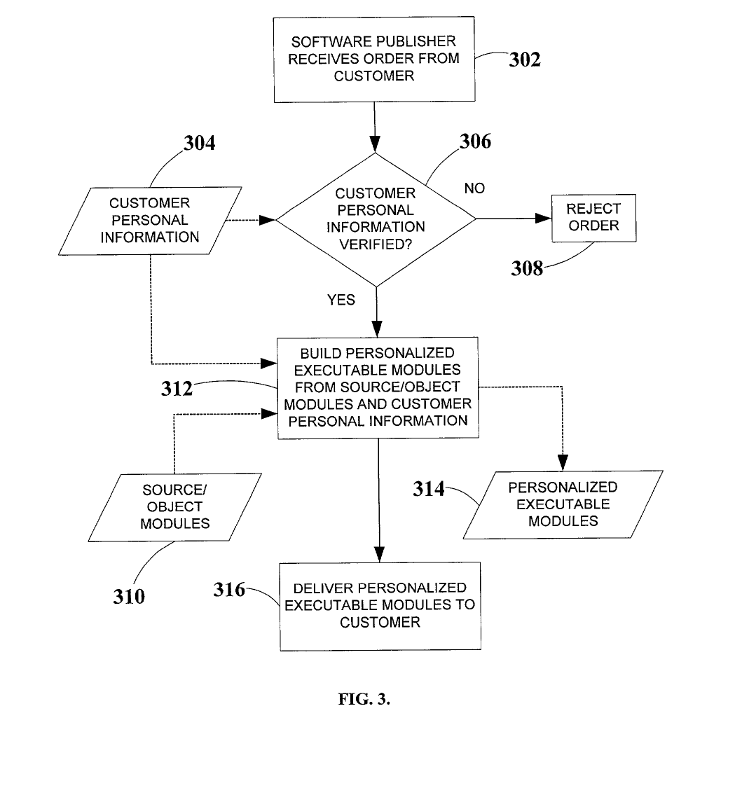

First, it is noted that in the case of software including a number of executable modules, not all the executable modules need be personalized in the manner previously described and illustrated (FIG. 3). It is usually sufficient that a single primary executable module be personalized. Thus, in general it is not necessary that all the modules of the software be involved in the personalization process, and therefore only a portion of the build need be affected.

Second, as is appreciated in the art, the most time-consuming portion of the build process is typically that of compilation (in the case of the three-step process detailed above, which is the most common). The final step, that of linking, is generally a fast process. Depending on the technique for incorporating the personalization into the software (as detailed previously), compilation may not be necessary for the personalization itself. In such a case, it will be necessary to process the personalization only at link-time. For this, the object modules (produced by compilation) need be processed by the linker. The relatively time-consuming compilation process thus need be done only once for an unlimited number of linking operations, each of which can result in differently-personalized software.

### Authenticating and Validating a Personalization

As discussed previously, one of the limitations of prior-art techniques for personalizing software is that it is relatively easy for a user (who is often an authorized user) to alter the personalization of the software, especially if programmatic methods for doing so have been widely published by technically-skilled attackers. It is therefore desirable to have means for authenticating and subsequently validating a personalization. As previously discussed, the prior-art Samson patent disclosed a means of authenticating and validating a serial number, utilizing mathematical functions for generating special serial numbers and complementary mathematical functions for validating these serial numbers. Here, however, the information to be authenticated is not a serial number (which has no predetermined significance and may therefore be arbitrarily determined by a mathematical function), but pre-existing personal information of the authorized user, which is necessarily predetermined and fixed in some sense. Techniques of authentication of such information are widely available in the form of cryptographic methods.

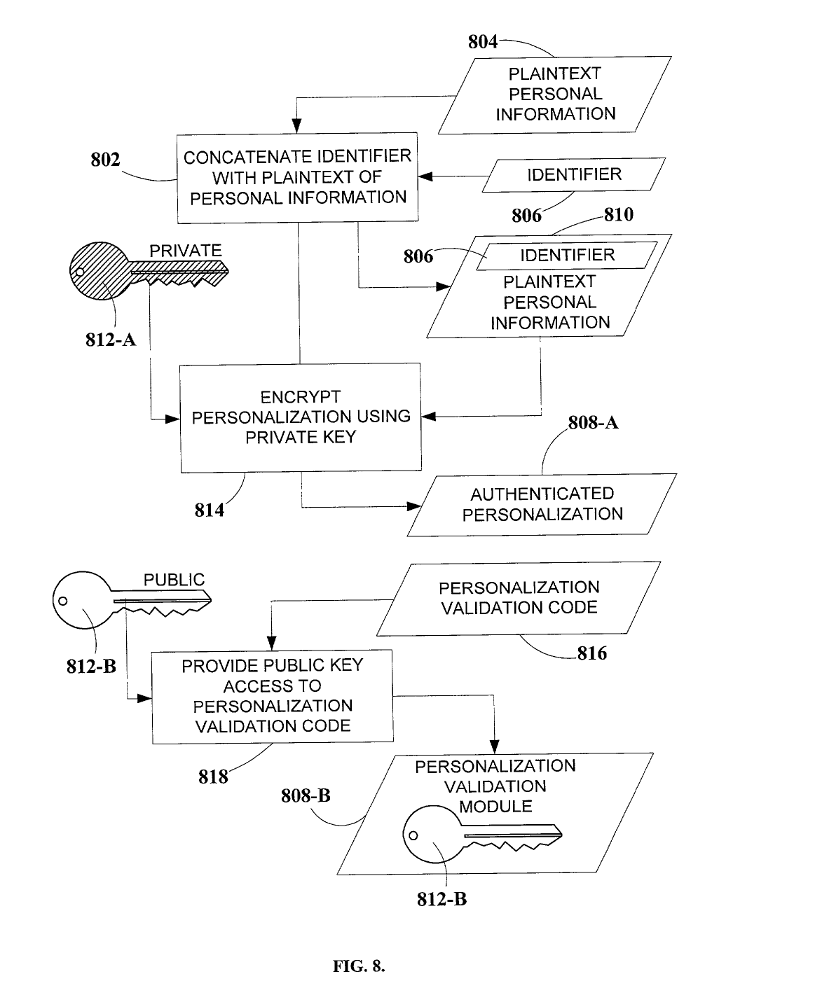

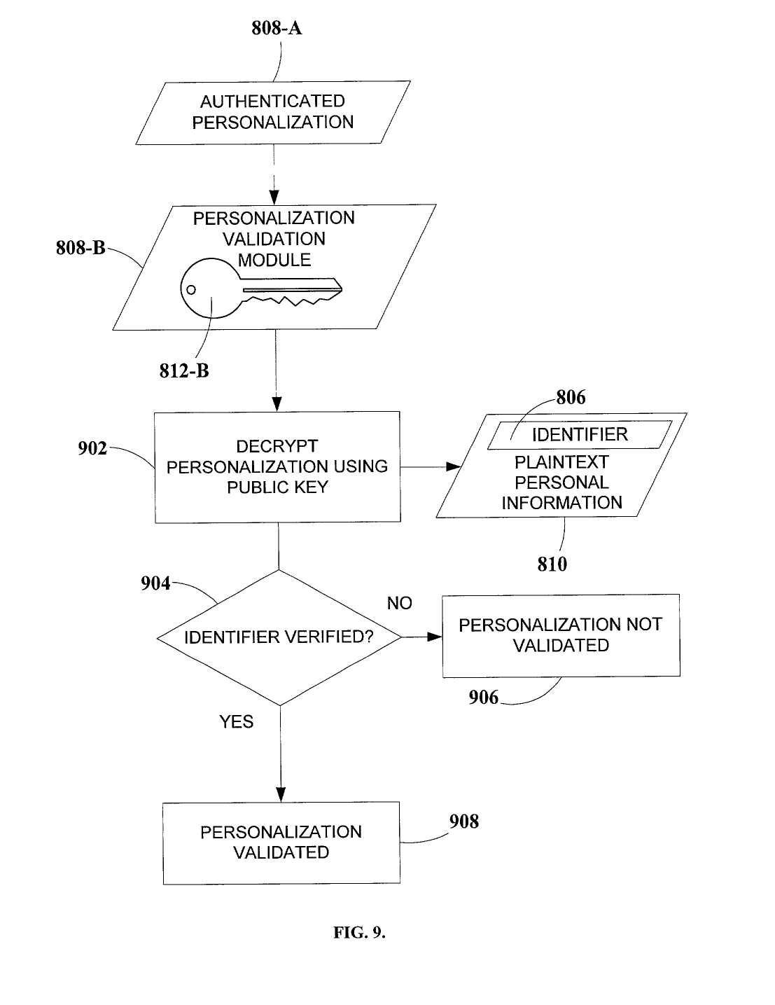

In an embodiment of the present invention, the personal information is authenticated prior to or during the software build by encrypting with an encryption key and then embedding the encrypted form of the personal information in the information stream of the deliverable published software. Because the build process can be completely under the control of the software publisher, the software publisher can therefore control the authentication of the personal information. In this embodiment, the personalization verification module subsequently decrypts the relevant code blocks of the information stream at run-time to determine if the personal information is intact, or if there have been any alterations. The personal information may thus be determined by the personalization verification module to have been originated by the software publisher and not to have been altered in any way. To do this, the personalization verification module needs to have access to the decryption key. As is well-known, however, if the same key is used for both encryption and decryption (such as in symmetric cryptosystems such as DES, IDEA, and so forth), then it is possible for an attacker to discover the encryption key by analyzing the personalization verification module of the software, and thereby forge a different personalization, in exactly the same way that technically-skilled attackers are currently able to forge prior-art software keys. FIG. 8, therefore, illustrates the operation of another embodiment of the present invention wherein a public key cryptosystem having a private key 812-A and a public key 812-B is used to provide different keys for encryption and decryption, to prevent an attacker from being able to forge a personalization. Examples of suitable public key cryptosystems include RSA and El Gamal. Initially, the desired personal information is in the form of a plaintext 804 which is not authenticated. There is also provided an identifier 806. In a step 802 the software publisher concatenates identifier 806 with plaintext 804 to produce a personalization 810 containing identifier 806. The purpose of identifier 806 is to provide an element within personalization 810 that can be recognized deterministically for validation, as is discussed below. In the simplest embodiment, identifier 806 is a constant, such as a predetermined number or character string. In another embodiment, identifier 806 is a pair of predetermined numbers which have a functional relationship. Next, in a step 814, the software publisher encrypts personalization 814 using private key 812-A to produce an authenticated personalization 808-A. In accordance with well-known methods, the software publisher keeps private key 812-A secret, but is able to publish public key 812-B. Accordingly, in a step 818, the software publisher provides access to public key 812-B to personalization validation code 816, thereby creating a personalization validation module 808-B containing public key 812-B. Personalization validation module 808-B is a rigorous form of the personalization verification module previously discussed, which is able not only to verify the presence of personalization 808-A, but is able to validate the personalization to establish the source and integrity thereof. By using separate keys for encryption and decryption in this way, it is assured that an attacker can obtain only the public key by analysis of the personalization validation module. This means that, at worst, an attacker can remove the personalization from a copy of the software, or perhaps substitute a different personalization for the original personalization, but (assuming that the public key cryptosystem is secure), an attacker could not forge or alter a personalization. FIG. 9 conceptually illustrates the operation of an embodiment of the present invention wherein personalization validation module 808-B uses the contained public key 812-B to validate authenticated personalization 808-A at run-time. In a step 902 personalization validation module 808-B decrypts personalization 808-A using public key 812-B to yield personalization 810 containing identifier 806. Next, in a decision point 904, personalization validation module 808-B verifies identifier 806. If, for example, identifier 806 is a simple constant, personalization validation module 808-B merely compares the correct constant value against the embedded contents of personalization 810 at the location where identifier 806 should be. If identifier 806 is verified, then in a step 908, personalization 810 is validated. Otherwise, personalization 810 is not validated.

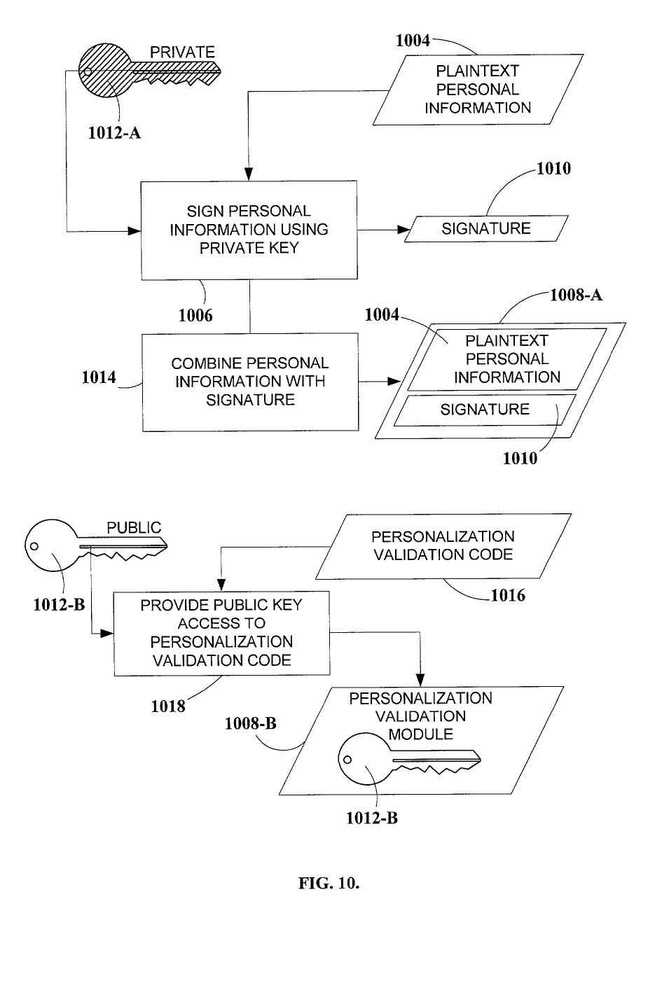

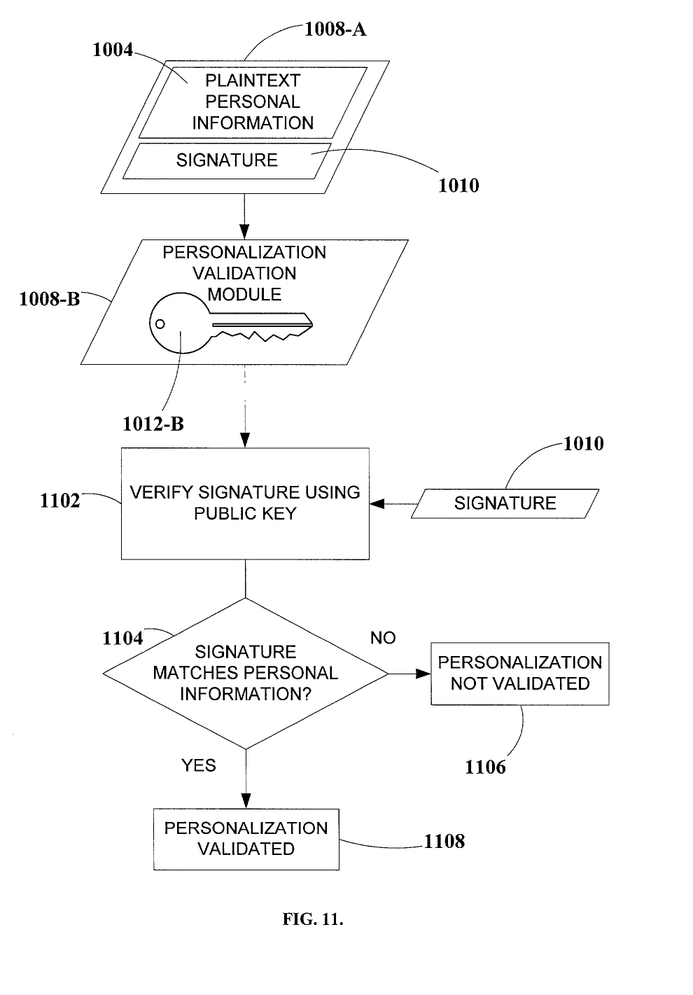

FIG. 10 illustrates another embodiment of the present invention, in which plaintext personal information 1004 is authenticated by using one of the available digital signature techniques, such as the well-known Digital Signature Algorithm (DSA) or the El Gamal signature scheme, which feature a private key 1012-A and a public key 1012-B. As with a public key cryptosystem, private key 1012-A is kept secret by the software publisher, while public key 1012-B is available for publication. Optionally (not illustrated in FIG. 10), personal information 1004 may be first processed to obtain a “hash” or “message digest” of the information using a cryptographically secure one-way function, such as the Secure Hash Algorithm (SHA). In a step 1006, the software publisher signs personal information 1004 to obtain a digital signature 1010, and in a step 1014 personal information 1004 is combined with digital signature 1010 to form a personalization 1008-A, which is inserted or encoded into the information stream of the software for the build, as previously described. In a manner analogous to the procedure previously described for public key cryptosystem authentication, in a step 1018, public key 1012-B is made accessible to personalization validation code 1016 to form a personalization validation module 1008-B, which is also inserted into the information stream of the software for the build. FIG. 11 conceptually illustrates the procedure for validating personalization 1008-A at run-time by personalization validation module 1008-B. Digital signature 1010 is extracted from personalization 1008-A, and in a step 1102, digital signature 1010 is verified according to the particular digital signature system in use. In a decision point 1104, if digital signature 1010 matches personal information 1004, then in a step 1108 personalization 1008-A is validated. Otherwise, in a step 1106, personalization 1008-A is not validated.

A personalization validation module as described can present in most cases a formidable barrier to all but the most skilled and determined attackers. In addition, as described below, it is sometimes possible to authenticate and validate the entire executable module (especially in the case of Java-based software), and doing so can render any attack futile. It is furthermore sometimes possible to employ the personalization to protect the software in ways that cannot be affected by attack on any one copy or instance of the software.

### Authenticating and Validating an Executable Module Containing a Personalization

It has been previously described how the authentication and subsequent validation of a personalization are desirable, to prevent a personalization from being altered or forged. The authentication and validation of a personalization, however, does not prevent an attacker from removing a personalization entirely, nor from substituting a different (valid) personalization for the one originally incorporated into the software. In addition, the personalization validation module is vulnerable to tampering and can in principle be modified by an attacker to answer that the personalization is valid, even when the personalization is invalid or missing. Because it is possible for an attacker to disable the personalization validation module in the software, it is possible for an attacker to render the software oblivious to the presence, absence, or altered condition of the personalization. Thus, it is also desirable to authenticate the entire software and require validation thereof prior to execution, to prevent the software from operating if there have been any alterations thereto, such as to the personalization validation module.

It is noted, however, that any module which is part of the software is vulnerable to attack. If the entire executable module is subjected to a validation test by an internal validation module, there is no guarantee that the integrity of the internal validation module has not been compromised by an attacker, and in such a case, the authentication and validation of the entire software will be unreliable. Therefore, in the below section entitled “Attack-Resistant Protection through External Validation”, is presented an embodiment of the present invention that extends the internal protection afforded by personalization to output files, to enable a software application to be validated externally by independent copies of the software application which are intact and uncompromised by attack.

Also below, in the section entitled “Extending the Java Protection Mechanism to Protect Software from Unauthorized Copying And Distribution”, is presented another embodiment of the present invention for use with Java software applications, by which the entire executable module may be securely validated.

### Employing the Personalization to Afford Protection to the Software

The mere presence of a embedded personalization in software can provide a modest amount of protection for the software, provided the authorized user is aware that the software contains this information and is reasonably secure against attack. If the authorized user knows that the software contains personal information that identifies or relates to him, he will be less willing to make and distribute unauthorized copies. To reinforce and bolster this protection, however, it is desirable to employ several measures to increase the authorized user's awareness of the personalization, to validate that the personal information has not been altered or removed, and to make the personal information more visible.

In an embodiment of the present invention, the software application is capable of displaying all or part of the personal information within the personalization, such as upon request by the user (in a “help window” or “about window”) or automatically when the software application is started (in a “splash window”), during regular execution of the software application (such as by putting the user's name in the “title bar” or “banner” of the software application's main window), or even interactively (such as by referring to the user by name when the software application makes a routine notification). In addition, many software applications request the user to enter his or her name for identifying output files, in a “properties” page (such as the author or creator of the output file). In an embodiment of the present invention, the user's name is automatically associated in such contexts by the software application itself, from the user's personal information in the personalization. Actions such as these can strongly associate the software with the individual authorized user, and in such a way that cannot be separated from the software, nor altered to have another user's identification.

Furthermore, if the personalization is missing or invalid, as determined by the personalization validation module (indicative of probable tampering in an attempt to disable or remove the personalization), the operation of the software can be modified in a suitable manner. As previously mentioned, the prior-art Samson patent teaches only a program termination as a response to an invalid or missing serial number. Program termination, however, is not always advisable, especially for software distributed over networks, where operational software can function in an advertising capacity. Therefore, in embodiments of the present invention, a number of alternatives to program termination are employed, where the personalization is invalid or missing. One alternative response to an invalid or missing personalization is to operate the software in a demonstration mode, or in one of the restricted modes characteristic of “freeware” versions of software, where the advanced features of the software may be missing or non-functional, or where the software is operational for a limited number of days before expiring. In such cases, it is best that the software not notify the user than an invalid or missing personalization is the cause of this response. If the user has been tampering with the software in an effort to remove or alter the personalization, and as a result the software no longer functions properly, the user should be allowed to consider that his tampering might have caused some damage to the code, rather than to confirm that anti-tampering measures are in place. It should be noted that this feature of the present invention does not constitute a form of usage restriction in the usual sense, because the deliverable published software containing an intact personalization is not associated with any usage restrictions. Only if the user attempts to remove, alter, or disable the personalization is any disabling of the software's functionality performed. It is thus not the personalization itself that is associated with any usage restrictions, but rather the user's tampering with the software that activates usage restrictions.

Although it is possible for the software to verify the existence and integrity of a personalization by including a personalization verification module, as described herein, there is no guarantee that a technically sophisticated attacker would not be able to remove or disable the personalization verification module while removing or altering the personal information. If this were done, then the software itself would be unable to determine that the personalization is invalid, and so the alternate modes of operation, as described above, would not be activated. As noted previously, however, proper cryptographic measures can assure that an attacker cannot forge or alter a personalization. Thus, according to the present invention, there are additional novel methods, described below, which in certain circumstances can afford some degree of protection to the software regardless of how a particular instance of the software may be attacked.

### Attack-Resistant Protection through External Validation

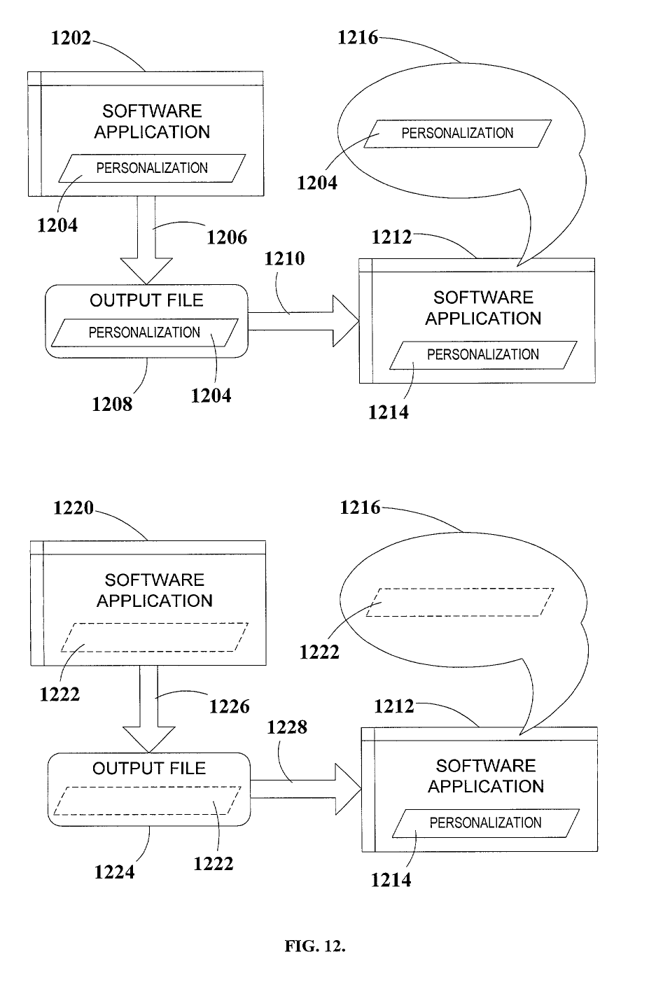

Attack-resistant protection according to the present invention relies on the existence of a user community where the existing copies of the software application are predominantly legitimate copies operated by authorized users, and where the various users regularly exchange output files from the software application among themselves. This provides an opportunity for “external validation” of the protected software. For example, in a corporate environment, users typically share business-related information among themselves by exchanging output files from software applications. FIG. 12 illustrates an embodiment of the present invention where a software application 1202 containing a personalization 1204 writes an output file 1208 containing a copy of personalization 1204 in each output operation 1206. Subsequently, when output file 1208 is read via an input operation 1210 by a different instance of the software application 1212 (containing a different personalization 1214), personalization 1204 is read into memory space 1216 of software application 1212 and can be validated by the personalization validation module (not shown) of software application 1212. Optionally, software application 1212 can display personalization 1204 for viewing by the user (for example, in viewing the “history” or “properties” of output file 1208). If, however, there exists an altered copy of software application 1220 which has been modified by tampering so that there is a missing or invalid personalization 1222, then after an output operation 1226, there will be an output file 1224 that also has a missing or invalid personalization 1222. Subsequently, when output file 1224 is input into software application 1212 during an input operation 1228, missing or invalid personalization 1222 is read into memory space 1216 of software application 1212 and will fail the validation test of the personalization validation module (not shown) of software application 1212. Thus, software application 1212 can determine that output file 1224 was created by a software application whose personalization has been altered and hence is an unauthorized copy of the software. In response to this condition, software application 1212 can take various kinds of predetermined actions, such as refusing to read output file 1224, or reading only certain portions of output file 1224. In such a manner, the use of a personalization can offer a certain level of protection to the software which is resistant to attack, regardless of the skill of the attacker. This particular feature of the present invention thereby provides a unique measure of protection to deliverable published software, which is completely unavailable in the prior art. If external validation is employed according to the present invention, as described above, then it is possible to provide protection against “reverse engineering” and/or imitation of the software. It often happens that a software application will become so popular that competing software publishers will seek to produce and sell a version that is compatible with that of the original. The historical example of the “Lotus 1-2-3” spreadsheet program is well-known, with various competitors introducing similar products that were able to read and write spreadsheet files in the “Lotus 1-2-3” format. Having this file compatibility was important to the competing products, because it facilitated entry and acceptance in a market dominated by the original “Lotus 1-2-3” product. Although Lotus vigorously defended the proprietary rights to the “1-2-3” spreadsheet application through legal action, it was impossible to legally prevent other software publishers from enabling their competing products from being able to read and write spreadsheet files in the “Lotus 1-2-3” format, and the competing products thereby gained easy entry and acceptance into the market and eventually displaced Lotus from the dominant position. A software application according to the present invention, however, would have a certain degree of protection against a similar competitive attack. Competing software publishers might be able to make their imitative products compatible with the file formats utilized by the protected original software application (such as through reverse engineering or other techniques), but they would never be able to duplicate the digital signature used in the personalization of the protected original software application. As a result, although the competing imitative products might be able to read and utilize output data file from the protected original software application, the competing imitative products would never be able to produce output data files that would be accepted by the majority of the software applications currently in the marketplace, since these protected applications require a valid personalization to be included in an output data file. This factor would hinder the entry and acceptance of competing products into the marketplace and would further protect the software publisher of the original protected software application.

There is a further benefit to be derived from including a personalization in output files. One of the problems encountered by certain software applications that have internal “macro” or script programming capabilities is in the spread of computer viruses, notably the so-called “macro” viruses, which can be passed from one computer to another via the output files of these software applications. By attaching a personalization to output files, and accumulating the personalizations as the output file is transferred from one user to another, it is possible to accurately identify the sources thereof. For example, a user who receives an output file from another user can easily verify the authenticity of the output file by viewing the personalization of the output file using the display capabilities of his copy of the software application. A virus detected in such an output file can thus be traced to the user where the virus originated. Alternatively, an output file lacking a validated personalization can be considered as possibly infected with a virus and automatically disabled.

It is noted that this technique requires using strong cryptographic measures to guarantee that an attacker cannot forge or alter a personalization. As previously detailed, this is possible with the present invention, but is impractical or impossible with prior-art personalization methods. It is further noted, however, that this technique is not always applicable. Certain software applications, for example, are required to write output files in a standard format, in which there is no provision for inserting extra information, such as a personalization. Other software applications may be expected or required to read input files generated by different software applications from other software publishers. Still other software applications do not have any provision for sharing files with other users. In cases such as these, it is not feasible to use output files containing a personalization to impart additional protection to the software application. Nevertheless, in many situations it is possible to employ this technique to strengthen the protection afforded by the personalization.

### Method of Software Personalization

Given software that has previously been developed and is available in source or object module form, the steps and elements of a basic method for personalizing the software according to the present invention have been previously described and illustrated in FIG. 3, FIG. 4, FIG. 5, and FIG. 8, and may be summarized as follows:

1. Receiving an order from a customer, in step 302.

2. Obtaining pre-existing customer personal information 304.

3. Optionally verifying customer personal information 304 in decision point 306, and

a. if customer personal information 304 cannot be verified, rejecting order in step 308; or

b. continuing with process if customer personal information 304 is verified.

4. Producing, from pre-existing customer personal information 304, personal information module 508-A as a source module.

5. Optionally authenticating personal information module 508-A to produce an authenticated personalization 808-A.

6. Optionally providing personalization verification module source 508-B, if necessary compiling into personalization validation code 816, to produce personalization validation module 808-B as an object module.

7. Taking all source modules 404, or object modules 406-B, including personal information module 508-A, and performing compiling/assembling/interpreting/linking operation 406 to produce executable modules 408, which derive from previously-developed modules for the software, including personal information module 508-A containing pre-existing customer personal information 304. Executable modules 408 constitute deliverable personalized executable modules 314.

8. Deliver personalized executable modules 314 to the customer in step 316.

It is noted that the previously-developed software can include not only personalization validation module source 508-B but also code for the selective display of the personalization by the software at run-time, incorporation of the personalization in output files, and so forth, as previously described.

### Extending the Java Protection Mechanism to Protect Software from Unauthorized Copying And Distribution

As previously noted, software relying solely on any kind of internal protection is fundamentally insecure and depends on obscurity for resistance to attack. Once compromised by attack, all protective features of such software can be disabled by modification or removal. Having the software itself detect such modification with an internal validation module is obviously of limited value, because the internal validation module itself is vulnerable to attack. It is thus desirable to implement means by which a software application can be fully validated independently through the use of external facilities.

In the case of Java-based software applications, for example, there is a provision by which validation of an authenticated software application is not done internally by the software itself, but by the external and independent Java interpreter, which has been separately loaded in the user's computer. As previously described, this independent verification is necessary to provide security to the user from malicious software, by guaranteeing that the software originates from a reputable source and has not been altered in any way. It is therefore not in the user's interest to disable the Java validation. Consequently, Java-based software can be authenticated such that if any changes are made to the software (such as by an attacker), the software will not pass validation at run-time and will not have access to the full range of resources of the computer. This means that authenticated Java-based software that has been altered by an attacker will not function properly on the majority of existing Java platforms, regardless of the technical skill of the attacker.

Therefore, in an embodiment of the present invention utilizing such a Java platform, the personalization embedded in the software cannot be removed, replaced, or substituted, nor can the personalization validation module of such software be disabled by an attacker without destroying the functionality of the software. It is noted that, because the Java validation utilizes a secure public key cryptosystem and does not contain the private key necessary to sign the authentication, it is not possible to forge an authentication, nor is it possible to successfully attack the security of the system by analyzing the Java platform security manager or the Java Virtual Machine. In such cases, then, it is not possible to distribute working unauthorized copies of the software that have been modified in any way. Thus, according to the present invention, the Java mechanism for protecting client computers from untrusted software is extended to protect the software from unauthorized copying and distribution.

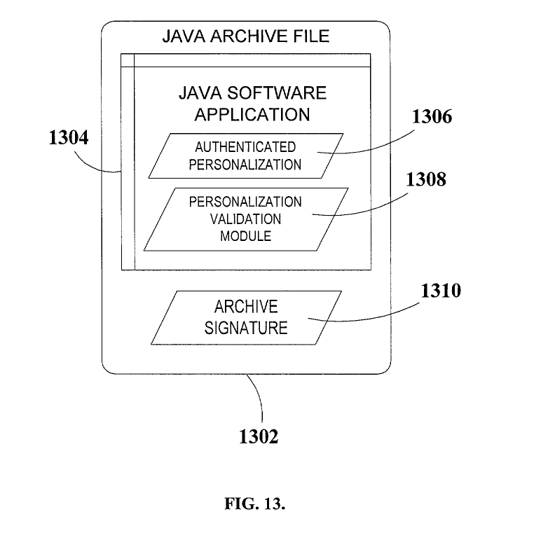

FIG. 13 conceptually illustrates a Java software application 1304 having an authenticated personalization 1306 and a personalization validation module 1308 according to the present invention, and which is further contained within a Java archive file 1302 which has been authenticated with an archive signature 1310. The method for including authenticated personalization 1306 and personalization validation module 1308 in software application 1304 has been detailed herein. A technique for incorporating software application 1304 within Java archive file 1302 and authenticating with archive signature 1310 is well-known in the prior art, and makes use of elements in the Java Software Development Kit (SDK). In particular, the JAR (Java ARchive) Signing and Verification Tool (“jarsigner”) and the associated documentation distributed with it details the concept and how to “sign” (authenticate) a Java archive, and how the signature validation works.

### Other Uses for a Personalization

There are additional and unexpected advantages to be gained by inserting a personalization according to the present invention into a software application, which stem from the fact that authorized copies of software applications so personalized can easily be made to be unique (on account of the personalization), and the unique aspect of the authorized copy of the software application is accessible to the software application. It is possible, therefore, to use this unique information, or some part thereof, to identify data created by an authorized copy of the software application with an identifier that is guaranteed to be different from any other such identifier, created either by the same authorized copy or by any other authorized copy.

A simple way of doing this is to assign a first portion of the identifier according to the date and time the identifier is created. The first portion will therefore be different from any other such first portion created by this authorized copy of the software application because each such first portion must necessarily be created at a different time. The first portion is then concatenated with a second portion which is assigned according to the personalization of the authorized copy of the software application that is creating the identifier. The second portion is different from any other such second portion created by a different authorized copy of the software application because the personalizations are different for each authorized copy. Thus, the concatenated portions form an identifier that is different from any other such identifier.

Other schemes for utilizing a personalization to generate a unique identifier are also possible.

Although it is possible to achieve similar results by differentiating copies of the software application in other ways (such as by a serial number), the use of a personalization discourages unauthorized copying and distribution and thereby reduces the probability that multiple copies of the software application will have the same identifier.

### System for Personalizing Software

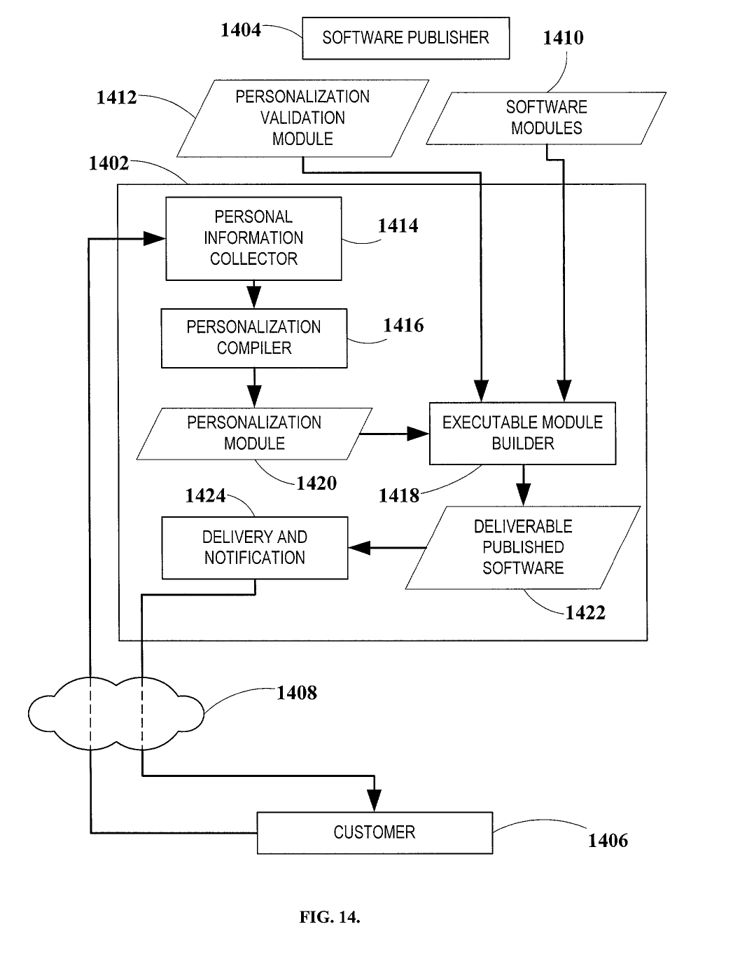

FIG. 14 conceptually illustrates a system 1402 for personalizing deliverable published software from a software publisher 1404 to a customer 1406 according to the present invention. Software publisher 1404 interacts with customer 1406 through a channel 1408, non-limiting examples of which include networks such as the Internet. As with published software in general, software publisher 1404 has previously developed software modules 1410, which may be in any suitable form, including, but not limited to, source, object, or executable form. Software modules 1410 substantially constitute or determine the principal functional form of the software published by software publisher 1404. Software publisher 1404 also optionally has available a personalization validation module 1412, whose function and purpose has been previously described herein.

System 1402 contains a personal information collector 1414, which obtains personal information about customer 1406, and optionally verifies the personal information. The personal information can be obtained directly from customer 1406 or indirectly through a third party or other source, such as references supplied by customer 1406, credit bureaus, employers, banks, official departments of vital statistics, and so forth, as may be legally permissible and/or as authorized by customer 1406. For example, a software publisher might negotiate a volume purchase agreement with a large employer to supply employees with a software application for their work. In such a case, the employees would be the customers, and the employer could furnish suitable personal information about them (such as their name, title, company, etc.) to the software publisher on their behalf. Such third parties and other sources can also be used to verify the personal information.

In a preferred embodiment of the present invention, personal information collector 1414 is an applet that runs in a web browser operated by customer 1406 and connected to a website established by software publisher 1404 for the purpose of receiving orders for the software. In this embodiment, personal information collector 1414 has data fields for the desired personal information, and when customer 1406 places an order for the software, he or she fills in these data fields with the requested personal information, and submits the order with the personal information directly over the Internet. Some of this personal information (in particular, the customer's name) will be associated with the credit-card payment details, and will therefore be verified when the credit card information is confirmed with the bank prior to fulfilling the order.

Personal information collector 1414 then furnishes the personal information about the customer to a personalization compiler 1416, which renders this information into a format which can serve as the input to an executable module builder 1418. Here, the term “personalization compiler” denotes any tool or facility capable of taking the collected personal information and creating a personalization module 1420, for inclusion into a build. Various different tools exist for such a purpose, including, but not limited to compilers, assemblers, resource compilers, and the like. For example an applet serving as personal information collector 1414 in the embodiment previously noted can output the data in the personal information fields as string table data in *.rc format for a standard resource compiler. Alternatively, personal information collector 1414 can output the data in assembly (*.ASM) format for an assembler.

Next, executable module builder 1418 takes software modules 1410, personalization module 1420, and optional personalization validation module 1412, and outputs deliverable published software 1422 containing personalization for customer 1406. Finally, a delivery and notification unit 1424 sends a notification to customer 1406 and/or downloads deliverable published software 1422 thereto, such as by channel 1408. In a preferred embodiment of the present invention, delivery and notification unit 1424 sends e-mail to customer 1406 with instructions on how to download deliverable published software 1422, or may send deliverable published software 1422 directly to customer 1406 via an e-mail attachment.

In a preferred embodiment of the present invention, software modules 1410 and personalization module 1420 are in object (*.obj) format and executable module builder 1418 is a linker that outputs deliverable published software 1422 in executable (*.exe) format.

While the invention has been described with respect to a limited number of embodiments, it will be appreciated that many variations, modifications and other applications of the invention may be made. It will be recognized by those skilled in the art that changes can be made in the embodiments without departing from the spirit and scope of the present invention. The scope of the invention is not to be restricted, therefore, to the specific embodiments, and it is intended that the appended claims cover any and all such applications, modifications, and embodiments within the scope of the present invention, as appropriately interpreted in accordance with the doctrine of equivalents.

I claim:

1. In an information stream associated with deliverable published software from a software publisher to a customer, an arrangement for software protection comprising a personalization, said personalization incorporated into the information stream by the software publisher and containing pre-existing personal information fundamentally related to the customer.

2. The arrangement as in claim 1, wherein the deliverable published software is intended to execute on a plurality of computers, and wherein said personalization is not fundamentally related to any specific computer of the plurality.

3. The arrangement as in claim 1, wherein the deliverable published software is intended to execute on a plurality of computers, each of the plurality of computers having a configuration, and wherein said personalization is not fundamentally related to any specific configuration.

4. The arrangement as in claim 1, wherein the deliverable published software is intended to execute on computers belonging to a class of computer, and wherein the deliverable published software executes in substantially identical functional form on substantially all computers of the class of computer.

5. The arrangement as in claim 1, wherein said personalization is not associated with, and does activate, any usage restriction on the deliverable published software.

6. The arrangement as in claim 1, wherein said personalization does not have a fixed address within the information stream.

7. The arrangement as in claim 1, wherein said personalization does not have a fixed extent within the information stream.

8. The arrangement as in claim 1, wherein said personalization is authenticated.

9. The arrangement as in claim 8, wherein said personalization is in an encrypted form within the information stream.

10. The arrangement as in claim 1, wherein the information stream contains at least one executable module operative to displaying at least part of said personalization.

11. The arrangement as in claim 1, wherein the information stream contains at least one executable module, and wherein said personalization is contained within said at least one executable module.

12. The arrangement as in claim 1, further comprising a personalization validation module operative to validating a personalization.

13. The arrangement as in claim 12, wherein said personalization verification module is further operative to validating an output file.

14. The arrangement as in claim 12, wherein the information stream contains at least one executable module, and wherein said personalization verification module is further operative to validating said at least one executable module.

15. The arrangement as in claim 12, wherein said personalization validation module is further operative, upon not detecting a valid personalization, to initiate an action included in the group containing:
(a) program termination;
(b) operating the software in a demonstration mode; and
(c) operating the software in a restricted mode.

16. The arrangement as in claim 1, wherein the information stream contains at least one executable module having an authentication, and wherein said executable module executes in a secure computer environment operative to validating said authentication.

17. The arrangement as in claim 1, wherein at least part of the deliverable published software is written in the Java language.

18. The arrangement as in claim 17, wherein at least part of the deliverable published software is contained in a Java archive.

19. The arrangement as in claim 18, wherein said Java archive is signed with an archive signature.

20. The arrangement as in claim 16, wherein said secure computer environment is operative to executing Java software.

21. The arrangement as in claim 12, wherein said personalization is in an encrypted form within the information stream, and wherein said personalization validation module is further operative to decrypting said encrypted form.

22. The arrangement as in claim 21, wherein said encrypted form is according to a public key cryptosystem having a public key, and wherein said personalization validation module has access to said public key.

23. The arrangement as in claim 1, wherein the information stream contains at least one executable module operative to writing an output file containing information derived from said personalization.

24. A method for protecting published software ordered by a customer, the method comprising the steps of:
(a) obtaining pre-existing personal information fundamentally related to the customer;
(b) producing, from said pre-existing personal information fundamentally related to the customer, a personal information module; and
(c) producing an executable module deriving at least in part from said personal information module and incorporating said pre-existing personal information fundamentally related to the customer.

25. The method as in claim 24, further comprising the steps of:
(d) authenticating said personal information module; and
(e) providing a personalization validation module, from which derives at least in part said executable module.

26. The method as in claim 24, further comprising the steps of:
(d) incorporating said executable module within a Java archive; and
(e) authenticating said Java archive with an archive signature.

27. The method as in claim 25, further comprising the steps of:
(f) incorporating said executable module within a Java archive; and
(g) authenticating said Java archive with an archive signature.

28. A system for protecting published software ordered by a customer, the system comprising:
(a) a personal information collector for collecting pre-existing personal information fundamentally related to the customer;
(b) a personalization compiler, for producing, from said pre-existing personal information fundamentally related to the customer, a personalization module; and
(c) an executable module builder, for producing deliverable published software containing said pre-existing personal information fundamentally related to the customer and derived at least in part from said personalization module.
